(19) United States
(12) Patent Application Publication
(10) Pub. No.: US 2026/0016796 A1
(43) Pub. Date: Jan. 15, 2026

(54) CONTROL APPARATUS, CONTROL SYSTEM, CONTROL METHOD, AND NON-TRANSITORY STORAGE MEDIUM

(71) Applicant: KABUSHIKI KAISHA TOSHIBA, Tokyo (JP)

(72) Inventors: Makihiko ISHITANI, Yokohama (JP); Kenji HIROHATA, Tokyo (JP); Akira KANO, Kawasaki (JP); Ryuji TAKAHASHI, Kawasaki (JP)

(73) Assignee: KABUSHIKI KAISHA TOSHIBA, Tokyo (JP)

(21) Appl. No.: 19/262,257

(22) Filed: Jul. 8, 2025

(30) Foreign Application Priority Data
Jul. 9, 2024 (JP) 2024-110511

(51) Int. Cl. G05B 13/04

(52) U.S. Cl. CPC G05B 13/04

(57) ABSTRACT

In an embodiment, a control apparatus includes a control unit, and the control unit generates a control command related to an operation of a plurality of control target elements in a state of suppressing a variation in degradation among the plurality of control target elements based on degradation information related to the degradation of the plurality of control target elements. The control unit inputs the generated control command to a control target facility including the plurality of control target elements to cause the control target facility to execute an operation corresponding to the control command.

### CROSS-REFERENCE TO RELATED APPLICATIONS

This application is based upon and claims the benefit of priority from Japanese Patent Application No. 2024-110511, filed Jul. 9, 2024; the entire contents of which are incorporated herein by reference.

### FIELD

Embodiments described herein relate generally to a control apparatus, a control system, a control method, and a non-transitory storage medium.

### BACKGROUND

In controlling an operation of a control target facility including a plurality of control target elements, a control unit including a processor, an integrated circuit, and the like generates a control command related to the operation of the plurality of control target elements based on an operation command regarding the control target facility input from an outside. Then, the control unit inputs the generated control command to the control target facility to cause the control target facility to execute an operation corresponding to the control command.

In a case where the operation of the control target facility including the plurality of control target elements is continued as described above, a variation in degradation occurs among the plurality of control target elements due to any of an error at the time of manufacturing, a difference in arrangement environment, a difference in operation status, or the like. If the variation in degradation among the plurality of control target elements increases, timing at which a failure or the like occurs also greatly varies among the plurality of control target elements. Further, if the variation in degradation among the plurality of control target elements increases, for example, the entire operation of the control target facility needs to be stopped in a case where the failure or the like occurs in one control target element having a large degradation degree even if the degradation degree is small in most of the control target elements. From the above-described viewpoint, the control target facility including the plurality of control target elements is required to appropriately operate the control target facility while suppressing the variation in degradation among the plurality of control target elements.

### BRIEF DESCRIPTION OF THE DRAWINGS

FIG. 1 is a block diagram schematically illustrating an example of a configuration of a control system according to an embodiment.

FIG. 2 is a block diagram schematically illustrating a first example of a control lineage that controls operations of a plurality of control target elements and a control target facility.

FIG. 3 is a block diagram schematically illustrating a second example of the control lineage that controls operations of a plurality of control target elements and a control target facility.

FIG. 4 is a block diagram schematically illustrating a third example of the control lineage that controls operations of a plurality of control target elements and a control target facility.

FIG. 5 is a block diagram schematically illustrating a fourth example of the control lineage that controls operations of a plurality of control target elements and a control target facility.

FIG. 6 is a schematic diagram for describing an example of processing of calculating degradation information related to degradation of the plurality of control target elements in the embodiment.

FIG. 7 is a flowchart schematically illustrating a first example of processing of calculating degradation indexes for one or more of the plurality of control target elements in the embodiment.

FIG. 8 is a flowchart schematically illustrating a second example of the processing of calculating a degradation index for one or more of the plurality of control target elements in the embodiment.

FIG. 9 is a schematic diagram illustrating an example of a display screen that displays a calculation result of the degradation index for one of the plurality of control target elements in the embodiment.

FIG. 10 is a block diagram schematically illustrating a first example of a communication lineage in the control system according to the embodiment.

FIG. 11 is a block diagram schematically illustrating a second example of the communication lineage in the control system according to the embodiment.

FIG. 12 is a block diagram schematically illustrating a first example of a control lineage that controls a storage battery facility that is a control target facility in the embodiment.

FIG. 13 is a schematic diagram illustrating an example of an operation command input to each of four control units in the example of FIG. 12.

FIG. 14 is a block diagram schematically illustrating a second example of the control lineage that controls a storage battery facility that is a control target facility in the embodiment.

FIG. 15 is a schematic diagram for describing an effect in a case where control by a control unit is performed in the embodiment.

FIG. 16 is a flowchart schematically illustrating processing performed in verification related to the embodiment.

FIG. 17 is a flowchart schematically illustrating processing performed in processing of calculating degradation information of FIG. 16.

FIG. 18 is a schematic diagram illustrating a time change in current of each of a plurality of batteries in a case of a comparative example, which was calculated in verification related to the embodiment.

FIG. 19 is a schematic diagram illustrating a time change in a degradation degree of each of a plurality of batteries in a case of a comparative example, which was calculated in verification related to the embodiment.

FIG. 20 is a schematic diagram illustrating a time change in current of each of a plurality of batteries in a case of an example, which was calculated in verification related to the embodiment.

FIG. 21 is a schematic diagram illustrating a time change in a degradation degree of each of a plurality of batteries in a case of an example, which was calculated in verification related to the embodiment.

### DETAILED DESCRIPTION

In an embodiment, a control apparatus includes a control unit, and the control unit generates a control command related to an operation of a plurality of control target elements in a state of suppressing a variation in degradation among the plurality of control target elements based on degradation information related to the degradation of the plurality of control target elements. The control unit inputs the generated control command to the control target facility including the plurality of control target elements to cause the control target facility to execute the operation corresponding to the control command.

Hereinafter, an embodiment will be described with reference to the drawings.

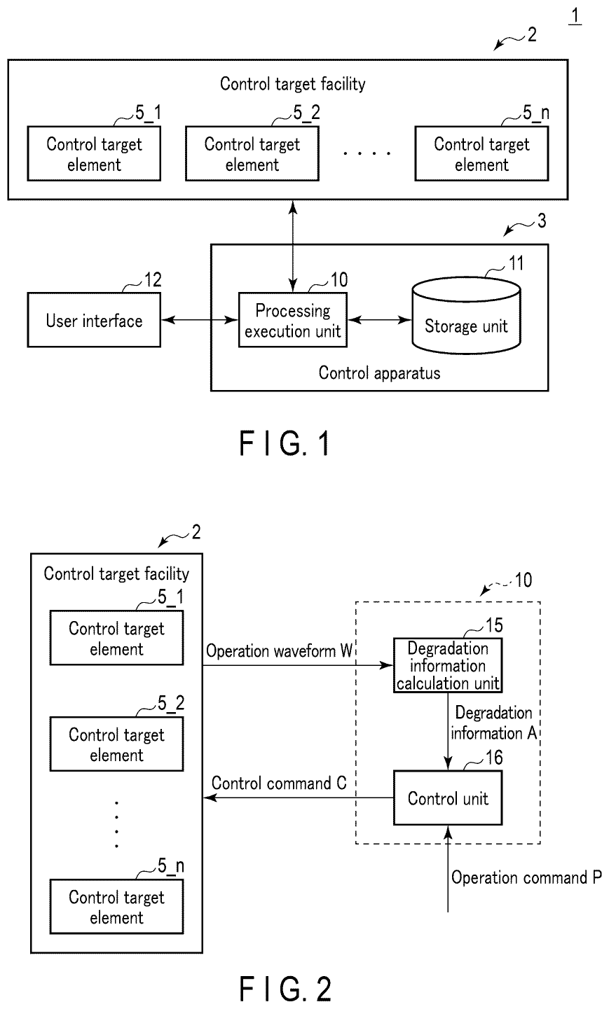

FIG. 1 is a block diagram schematically illustrating an example of a configuration of a control system 1 according to an embodiment. As illustrated in FIG. 1, the control system 1 includes a control target facility 2 and a control apparatus 3. In the control system 1, the control apparatus 3 manages an operational state and the like of the control target facility 2 and controls an operation of the control target facility 2. The control target facility 2 is also referred to as a “control target system” and an “overall control target”. The control target facility 2 includes a plurality of control target elements 5, and in the example of FIG. 1, n (n is a natural number of 2 or more) control target elements 5_1 to 5_n are provided in the control target facility 2. The control target facility 2 includes a plurality of components including the plurality of control target elements 5. The control apparatus 3 controls the operation of the control target facility 2 by controlling the operations of the plurality of control target elements 5. The control target element 5 is also referred to as a “partial control target”. Further, the control target elements 5_1 to 5_n are simply referred to as the control target element(s) 5 unless otherwise distinguished.

In one example, the control target facility 2 is a storage battery facility (storage battery system), and the storage battery facility includes a plurality of batteries as the plurality of control target elements 5. In this case, the plurality of batteries may be batteries of the same type with respect to each other, or one or more of the plurality of batteries may be batteries of a type different from the other batteries. Further, the battery serving as the control target element 5 may be a battery cell (single battery) or a battery module in which a plurality of battery cells is electrically connected. Further, in the control target facility 2, one or more of the plurality of control target elements 5 may be a component different from the other control target elements 5. In one example, the control target facility 2 is a storage battery facility, and includes one or more batteries, an air cooling fan, and an inverter as the plurality of control target elements 5. In this case, for example, direct-current power output from the battery is converted into alternating-current power by the inverter, and the battery and the inverter are cooled by the air cooling fan.

The control apparatus 3 includes a processing execution unit 10 and a storage unit 11. The storage unit 11 stores a program to be executed by the processing execution unit 10, and the processing execution unit 10 executes the program stored in the storage unit 11 to perform processing. In the present embodiment, a control program is stored in the storage unit 11, and the processing execution unit 10 executes the control program to control the operations of the plurality of control target elements 5, the overall operation of the control target facility 2, and the like, as will be described below. Further, the processing execution unit 10 acquires an operation state of one or more of the plurality of control target elements 5 and an entire operation state of the control target facility 2 from an operation waveform or the like detected in the control target facility 2. The processing execution unit 10 controls the operation of the control target element 5 based on the acquired operation state.

In one example, the control apparatus 3 includes, for example, computers (processing apparatuses) such as a server, a personal computer, and a terminal, and the computer constituting the control apparatus 3 includes a processor or an integrated circuit, and a non-transitory storage medium. In the computer, the processing execution unit includes the processor, the integrated circuit, or the like, and the storage unit 11 includes the storage medium. The processor constituting the processing execution unit 10 includes any of a central processing unit (CPU), an application specific integrated circuit (ASIC), a microcomputer, a field programmable gate array (FPGA), a digital signal processor (DSP), or the like. The processing execution unit 10 may include one processor or the like, or may include a plurality of the processors or the like.

Furthermore, in the computer, the non-transitory storage medium serving as the storage unit 11 includes either a main storage device such as a memory or an auxiliary storage device. Examples of the storage medium include a magnetic disk, an optical disk (CD-ROM, CD-R, DVD, or the like), a magneto-optical disk (MO or the like), a semiconductor memory, and the like. Only one storage medium serving as the storage unit 11 may be provided, or a plurality of storage media may be provided.

In one example, the processing execution unit 10 downloads programs including the control program from a computer different from the control apparatus 3 or a server in a cloud environment via a network. Then, the processing execution unit 10 executes the downloaded programs to perform processing to be described below. Furthermore, in another example, the control apparatus 3 includes a plurality of computers (a plurality of processing apparatuses) such as a plurality of servers, and processors and the like of the plurality of computers perform the processing to be described below by the processing execution unit 10 in cooperation with each other. Furthermore, in one example of the present embodiment and the like, at least a part of the control apparatus 3 includes a server in a cloud environment. An infrastructure of the cloud environment includes a virtual processor such as a virtual CPU and a cloud memory. In this case, the virtual processor performs at least part of processing to be described below by the processing execution unit 10, and the cloud memory constitutes at least part of the storage unit 11.

Further, the control system 1 of the example of FIG. 1 is provided with a user interface 12. In the user interface 12, a user or the like of the control system 1 inputs an appropriate operation related to the operation of the control target facility 2. Therefore, in the user interface 12, any of a button, a mouse, a touch panel, a keyboard, or the like is provided as an operation input unit to which the operation is input by the user or the like. Further, the user interface 12 is provided with a notification unit that notifies information related to the control target facility 2 and the plurality of control target elements 5. The notification unit notifies the information by any of screen display, transmission of sound, or the like. Note that the user interface 12 may be provided integrally with the computer or the like constituting the control apparatus 3, or may be provided separately from the computer or the like constituting the control apparatus 3. Furthermore, in one example, the user interface 12 may not be provided.

FIG. 2 is a block diagram schematically illustrating a first example of the control lineage that controls the operations of the plurality of control target elements 5 and the control target facility 2. In the control linage of the example of FIG. 2, the processing execution unit 10 includes a degradation information calculation unit 15 and a control unit 16, and each of the degradation information calculation unit 15 and the control unit 16 executes part of the processing of the processing execution unit 10. The processing to be described below performed by each of the degradation information calculation unit 15 and the control unit 16 is performed by, for example, the processor or the like of one or more computers. Further, at least part of the processing to be described below performed by each of the degradation information calculation unit 15 and the control unit 16 may be performed by the virtual processor or the like in the cloud environment.

In the example of FIG. 2, in the control target facility 2, the operation waveform related to any of the control target facility 2 and the plurality of control target elements 5 is detected by a detection unit such as a sensor. The detected operation waveform may be the operation waveform of any of the plurality of control target elements 5, or may be the operation waveform of any of the components other than the control target element 5 in the control target facility 2. For example, in the control target facility 2 provided with the battery, the air cooling fan, and the inverter as the plurality of control target elements 5, one or more operation waveforms of the battery, the air-cooling fan, and the inverter are detected. An example of the operation waveform of the battery includes the operation waveform indicating a time change in any of a current, a voltage, or a temperature of the battery, an example of the operation waveform of the inverter includes the operation waveform indicating a time change in any of the current or the temperature of the inverter, and an example of the operation waveform of the fan includes the operation waveform indicating a time change in any of the current or a rotation amount of the fan.

In the example of FIG. 2, an operation waveform W detected in the control target facility 2 is input to the degradation information calculation unit 15. The degradation information calculation unit 15 calculates degradation information A related to degradation of the plurality of control target elements 5 based on the input operation waveform W. Then, the degradation information calculation unit 15 inputs the calculated degradation information A to the control unit 16. In the degradation information A, for example, a degradation degree or the like is indicated as a degradation index for each of the plurality of control target elements 5. Note that, in the degradation information A, it is not necessary to indicate the degradation index such as the degradation degree for all of the plurality of control target elements 5, and the degradation index may be indicated only for some of the plurality of control target elements 5. In one example, a difference in the degradation index among the plurality of control target elements 5 is indicated as the degradation information A, and for example, a difference in the degradation degree among the plurality of control target elements 5 is indicated. Further, in another example, an identifier of the control target element 5 having the highest degradation degree among the plurality of control target elements 5 is indicated as the degradation information A.

Further, in a case where the degradation information A indicates the degradation index such as the degradation degree for one or more of the control target elements 5, the degradation index indicated by the degradation information A is not limited to the degradation degree in real time. In one example, the degradation information calculation unit 15 calculates a load history up to a present time point, that is, a load history in the past, for the control target facility 2, using the operation waveform W input from the control target facility 2. Then, the degradation information calculation unit 15 calculates, for one or more of the control target elements 5, the time change in the degradation degree or a damage value after the present time point in a case where the control target facility 2 continues the operation similar to the load history up to the present time point. Then, the degradation information calculation unit 15 calculates, for one or more of the control target elements 5, a life as a degradation index based on the time change in the degradation degree or the like after the present time point. The life of one or more of the control target elements 5 is indicated by, for example, a time or the number of cycles at which the degradation degree or the like reaches a criterion that serves as a reference for failure.

In another example, the degradation information calculation unit 15 calculates, for one or more of the control target elements 5, a time change in a failure probability after the present time point as a degradation index based on the time change in the degradation degree or the like after the present time point. In the example in which one of the life, the failure probability, or the like is calculated for one or more of the control target elements 5 as described above, one of the calculated life, failure probability, or the like is indicated as the degradation index in the degradation information A. For example, the degradation information calculation unit 15 calculates, for one or more of the control target elements 5, any of the degradation degree, the life, the failure probability, or the like as the degradation index using a surrogate model, and the calculated degradation index is indicated in the degradation information A. Note that a method of calculating the degradation degree, the life, the failure probability, or the like using the surrogate model will be described below.

In the example of FIG. 2, the degradation information A calculated by the degradation information calculation unit 15 is input to the control unit 16, and an operation command P for the control target facility 2 is input from the outside. The operation command P is input to the control unit 16 as a request command for satisfying a request from a global side such as a demand market. Furthermore, the operation command P is input to the control unit 16 in response to, for example, an operation input on the user interface 12 by the user or the like of the control system 1. In one example, a plurality of batteries is provided as the plurality of control target elements 5 of the control target facility 2, and a command value of the current in an entire power storage unit to which the plurality of batterie is electrically connected is input to the control unit 16 as the operation command P. In this case, the command value of the current in the entire power storage unit indicated by the operation command P becomes the request (condition) on the global side.

In the example of FIG. 2, the control unit 16 generates a control command C related to the operations of the plurality of control target elements 5 based on the degradation information A input from the degradation information calculation unit 15 and the operation command P from the outside. Then, the control unit 16 inputs the generated control command C to the control target facility 2 to cause the control target facility 2 to execute the operation corresponding to the control command C. For example, the control unit 16 generates the control command for the operation as the control command C for one or more of the plurality of control target elements 5. In one example, the control unit 16 generates the control command for the operation for each of the plurality of control target elements 5. Note that the control unit 16 does not need to generate the control commands for all of the plurality of control target elements 5, and may generate the control commands for only some of the plurality of control target elements 5.

In one example, a plurality of batteries is provided as the plurality of control target elements 5 of the control target facility 2, and the control unit 16 generates the control command indicating the command value of the current for one or more of the plurality of batteries as the control command C described above. Then, the control target facility 2 performs the operation corresponding to the control command C, whereby the current corresponding to the command value flows through the one or more corresponding batteries of the plurality of batteries.

Further, in the embodiment and the like, the control unit 16 may generate, as the control command C to be input to the control target facility 2, the control command for the operation of any component other than the plurality of control target elements 5, that is, the control command that does not directly act on any of the plurality of control target elements 5. In one example, in the control target facility 2, a plurality of batteries is provided as the plurality of control target elements 5, and the cooling fan is provided as a component other than the control target element 5. Then, in the storage battery facility to serve as the control target facility 2, the rotation amount of the cooling fan changes, whereby an air amount from the cooling fan to the batteries changes, and the rotation amount of the cooling fan affects the operation of the batteries. In this case, the control unit 16 generates the control command indicating the command value of the rotation amount for the cooling fan as the above-described control command C, and causes the control target facility 2 to execute the operation corresponding to the control command C.

In the embodiment and the like, the control command related to the operations of the plurality of control target elements 5 is generated in the state of suppressing a variation in degradation among the plurality of control target elements 5 based on the degradation information A. For example, it is assumed that the degradation information A indicates the degradation degree of each of the two control target elements 5_1 and 5_2 among the plurality of control target elements 5, and the degradation degree of the control target element (second control target element) 5_2 is higher than the degradation degree of the control target element (first control target element) 5_1. In this case, the control unit 16 generates the control command C related to the operations of the plurality of control target elements 5 in a state in which the load acting due to the control command C is smaller in the control target element 5_2 than in the control target element 5_1. For example, in a case where the control target elements 5_1 and 5_2 are the batteries, the control unit 16 makes magnitude (absolute value) of the command value of the current in the control command for the battery serving as the control target element 5_2 smaller than magnitude of the command value of the current in the control command for the battery serving as the control target element 5_1.

Further, the control unit 16 generates the control command C in a state of satisfying the request (condition) indicated by the operation command P input from the outside in addition to suppressing the variation in degradation among the plurality of control target elements 5. In a case where the control target facility 2 including the plurality of batteries as the plurality of control target elements 5 is provided, and the command value of the current in the entire power storage unit including the plurality of batteries is indicated as the request on the global side in the operation command P, the control target facility 2 performs the operation corresponding to the control command C, whereby the current input to the power storage unit becomes the magnitude corresponding to the command value of the current in the operation command P.

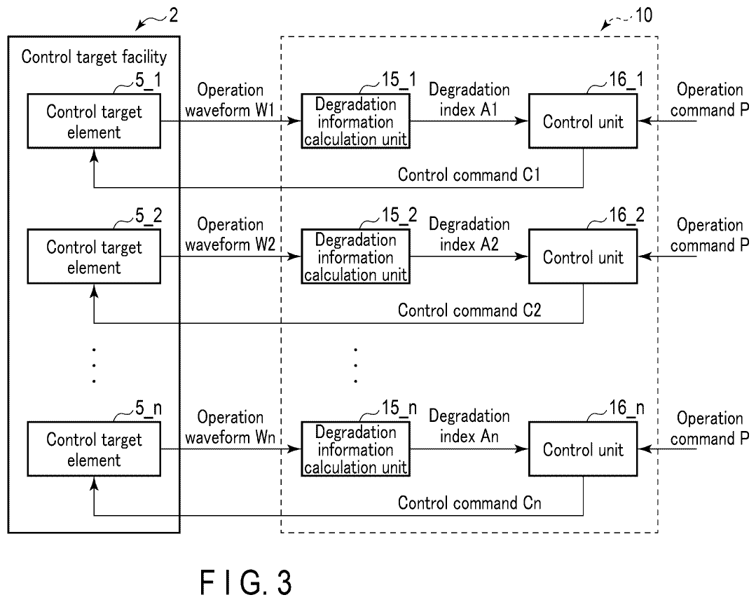

FIG. 3 is a block diagram schematically illustrating a second example of the control lineage that controls the operations of the plurality of control target elements 5 and the control target facility 2. In the control lineage of the example of FIG. 3, the processing execution unit 10 includes a plurality of the degradation information calculation units 15 and a plurality of the control units 16, and the same number of the degradation information calculation units 15 and the same number of the control units 16 as the number of control target elements 5 are provided. Then, one degradation information calculation unit 15 and one control unit 16 are provided for each of the plurality of control target elements 5. In the example of FIG. 3, the n (n is a natural number of 2 or more) control target elements 5_1 to 5_n, n degradation information calculation units 15_1 to 15_n, and n control units 16_1 to 16_n are provided. In one example, the control apparatus 3 includes the same number of processors and the like as the number of control target elements 5. Then, each of the plurality of processors and the like performs the processing by the corresponding one of the plurality of degradation information calculation units 15 and the processing by the corresponding one of the plurality of control units 16.

Note that, in the following description, the control target elements 5_1 to 5_n are simply referred to as the control target element(s) 5, the degradation information calculation units 15_1 to 15_n are simply referred to as the degradation information calculation unit(s) 15, and the control units 16_1 to 16_n are simply referred to as the control unit(s) 16, unless otherwise specified.

Further, in a case where any one of the plurality of control target elements 5 is defined as a control target element 5_k (k is any one of natural numbers of 1 or more and n or less), one corresponding to the control target element 5_k among the plurality of degradation information calculation units 15 is defined as a degradation information calculation unit 15_k, and one corresponding to the control target element 5_k among the plurality of control units 16 is defined as a control unit 16_k. Hereinafter, processing of each of the degradation information calculation unit 15_k and the control unit 16_k will be described. In the control linage of the example of FIG. 3, each of the plurality of degradation information calculation units 15 performs processing similar to that of the degradation information calculation unit 15_k to be described below, and each of the plurality of control units 16 performs processing similar to that of the control unit 16_k to be described below.

In the example of FIG. 3, the operation waveform of each of the plurality of control target elements 5 is detected in the control target facility 2. Therefore, operation waveforms W1 to Wn of the control target elements 5_1 to 5_n are detected. Further, in the example of FIG. 3, an operation waveform Wk of the control target element 5_k is input to the degradation information calculation unit 15_k. The degradation information calculation unit 15_k calculates a degradation index Ak of the control target element 5_k based on at least the input operation waveform Wk. Note that the degradation information calculation unit 15_k may calculate the degradation index Ak based on any of an operation waveform Wj of the control target element 5_j (j is other than k that is a natural number of 1 or more and n or less) other than the control target element 5_k and the operation waveform of the component other than the control target elements 5 in the control target facility 2, in addition to the operation waveform Wk.

In the example of FIG. 3, each of the plurality of degradation information calculation units 15 calculates a degradation index of a corresponding one of the control target elements 5. Therefore, in the example of FIG. 3, the degradation indexes of the control target elements 5_1 to 5_n, that is, degradation indexes A1 to An are indicated in the degradation information related to the degradation of the plurality of control target elements 5. The degradation information calculation unit 15_k inputs a calculation result of the degradation index Ak of the control target element 5_k to the control unit 16_k. Further, in the example of FIG. 3, the operation command P is input to each of the plurality of control units 16 from the outside.

In the example of FIG. 3, the control unit 16_k generates a control command Ck for the operation with respect to the control target element 5_k based on the degradation information and the operation command P. At this time, the control unit 16_k generates the control command Ck based on at least the degradation index Ak of the control target element 5_k input from the degradation information calculation unit 15_k and the operation command P described above. Furthermore, in one example, any of the degradation indexes Aj of the control target elements 5_j other than the control target element 5_k is input to the control unit 16_k. Then, the control unit 16_k generates the operation command for the control target element 5_k based on any one or more of the degradation indexes Aj in addition to the degradation index Ak and the operation command P.

In the example of FIG. 3, each of the plurality of control units 16 calculates the control command for the corresponding one of the control target elements 5 as described above. Therefore, in the example of FIG. 3, for each of the control target elements 5_1 to 5_n, the control command corresponding to the degradation index is generated as the control command related to the operations of the plurality of control target elements 5. That is, control commands C1 to Cn are generated as the control commands related to the operations of the plurality of control target elements 5. In the example of FIG. 3, the control unit 16_k inputs the generated control command Ck to the control target element 5_k. As a result, the control target element 5_k operates corresponding to the control command Ck from the control unit 16_k. That is, each of the plurality of control target elements 5 performs the operation corresponding to the control command from the corresponding one of the plurality of control units 16.

Even in the example of FIG. 3, each of the control units 16 generates the control command for the corresponding one of the plurality of control target elements 5 in the state of suppressing the variation in degradation among the plurality of control target elements 5. Then, each of the control units 16 generates the control command in the state of satisfying the request (condition) indicated by the operation command P in addition to suppressing the variation in degradation among the plurality of control target elements 5.

Note that, in one example, as in the example of FIG. 3, in the configuration in which the plurality of degradation information calculation units 15 is provided, one control unit 16 is provided in the cloud environment. In the present example, the degradation information calculation units 15_1 to 15_n transmit the above-described degradation indexes A1 to Ak to the control unit 16 in the cloud environment. Then, the control unit 16 in the cloud environment calculates the control commands for the respective control target elements 5_1 to 5_n, that is, the control commands C1 to Cn.

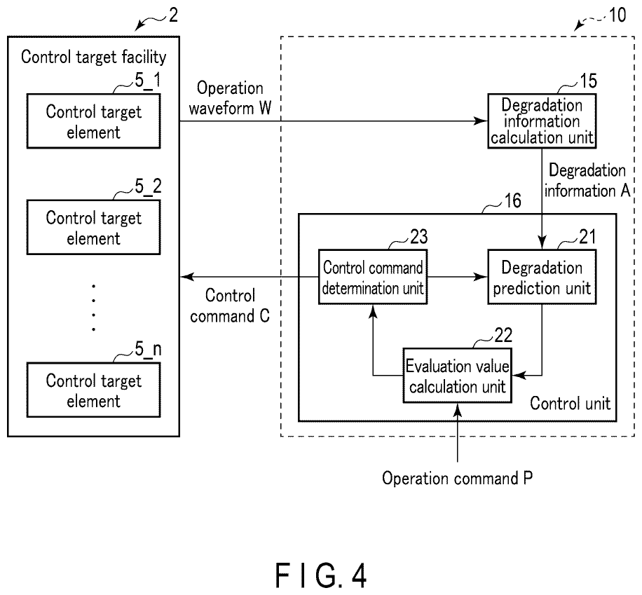

FIG. 4 is a block diagram schematically illustrating a third example of the control lineage that controls the operations of the plurality of control target elements 5 and the control target facility 2. In the control lineage of the example of FIG. 4, as in the example of FIG. 2, the processing execution unit 10 includes the degradation information calculation unit 15 and the control unit 16. Then, the control unit 16 generates the control command C related to the operations of the plurality of control target elements 5 based on the degradation information A and the operation command P. Note that, in the example of FIG. 4, the control unit 16 includes a degradation prediction unit 21, an evaluation value calculation unit 22, and a control command determination unit 23.

In the example of FIG. 4, the control unit 16 performs not only simple control such as PID control but also prediction regarding the degradation of one or more of the control target elements 5 using a degradation prediction model for the control target facility 2 and the control target element 5, and generates the control command C based on a prediction result using the degradation prediction model. Further, in the generation of the control command C, the control unit 16 can calculate the control command C by directly using the request (condition), a constraint, an objective function, and the like indicated by the operation command P from the outside.

In the example of FIG. 4, in the control unit 16, the control command determination unit 23 inputs a calculation result of the control command C calculated based on the degradation information A and the operation command P to the degradation prediction unit 21. Then, the degradation prediction unit 21 predicts the degradation of one or more of the control target elements 5 in a case where the calculated control command C is input to the control target facility 2, using the control command C input from the control command determination unit 23 and the degradation prediction model. At this time, the time change in the degradation degree after the present time point or the like in a case where the calculated control command C is input to the control target facility 2 is predicted for one or more of the control target elements 5.

In the example of FIG. 4, the evaluation value calculation unit 22 calculates an evaluation value indicating appropriateness of the calculated control command C based on the prediction result in the degradation prediction unit 21. At this time, the evaluation value calculation unit 22 reflects the request (condition), the constraint, the objective function, and the like indicated by the operation command P in addition to the prediction result in the degradation prediction unit 21 in the calculation of the evaluation value. For example, in a case where the command value of the current in the entire power storage unit including the plurality of batteries serving as the plurality of control target elements 5 is indicated as the request of the operation command P, the command value of the current in the entire power storage unit is reflected in the calculation of the evaluation value.

Further, in the example of FIG. 4, the control command determination unit 23 determines whether the control command C input to the degradation prediction unit 21 is appropriate based on the evaluation value calculated by the evaluation value calculation unit 22. Then, in a case where the control command C is appropriate, the control command determination unit 23 inputs the control command C determined to be appropriate to the control target facility 2. On the other hand, in a case where the control command C is not appropriate, the control command determination unit 23 corrects the control command C and inputs the corrected control command C to the degradation prediction unit 21.

Then, the degradation prediction unit 21 and the evaluation value calculation unit 22 perform the above-described processing, using the corrected control command C, and the control command determination unit 23 determines whether the corrected control command C is appropriate. Since the above-described processing is performed, the control unit 16 appropriately corrects and updates the control command C and the like based on the evaluation value. As a result, the control unit 16 optimizes the control command C input to the control target facility 2. Note that, in one example, the control unit 16 optimizes the control command C by using a C/GMRES method in which a continuation method and a generalized minimal residual method are combined without performing the above-described processing by the degradation prediction unit 21 and the evaluation value calculation unit 22.

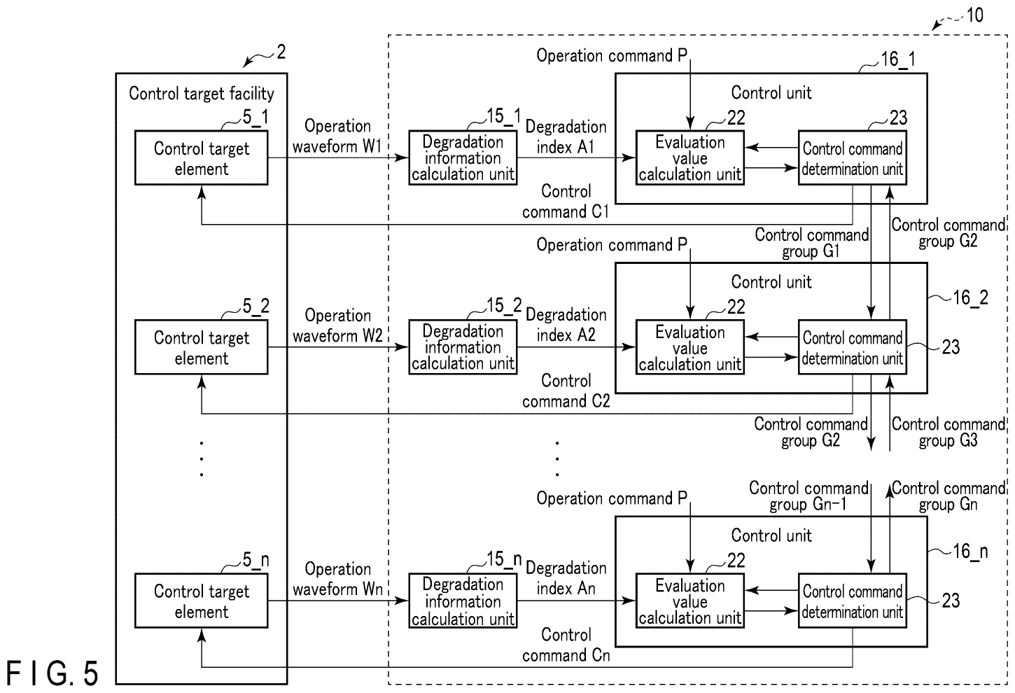

FIG. 5 is a block diagram schematically illustrating a fourth example of the control lineage that controls the operations of the plurality of control target elements 5 and the control target facility 2. In the control lineage of the example of FIG. 5, the same number of the degradation information calculation units 15 and the same number of the control units 16 as the number of control target elements 5 are provided similarly to the example of FIG. 3. Then, the degradation information calculation unit 15_k calculates the degradation index Ak of the control target element 5_k based on at least the operation waveform Wk of the control target element 5_k. Then, the control unit 16_k generates the control command Ck for the control target element 5_k based on at least the degradation index Ak of the control target element 5_k input from the degradation information calculation unit 15_k and the operation command P described above. Note that, in the example of FIG. 5, each of the control units 16 includes the evaluation value calculation unit 22 and the control command determination unit 23.

Further, in the example of FIG. 5, each of the control units 16 generates a control command group, and the plurality of control units 16_1 to 16_n generates control command groups G1 to Gn. For example, the control unit 16_k calculates a control command group Gk. Then, each of the control units 16 transmits the generated control command group to the other control units 16. Therefore, the control unit 16_k acquires each of control command groups Gj generated by the other control units 16_j. Therefore, the control command group is transmitted and received among the plurality of control units 16. In the example of FIG. 5, the plurality of control units 16 performs distributed optimization for the control commands for the plurality of control target elements 5, that is, the control commands C1 to Cn, using a consensus gradient algorithm.

Hereinafter, processing of the control unit 16_k will be described. In the example of FIG. 5, each of the plurality of control units 16 performs processing similar to the control unit 16_k described below. In the example of FIG. 5, the control command determination unit 23 of the control unit 16_k generates the control command Ck for the control target element 5_k based on at least the degradation index Ak of the control target element 5_k and the operation command P, and also generates the control command for each of the control target elements 5_j other than the control target element 5_k. That is, the control unit 16_k calculates a control command Cj in addition to the control command Ck, and calculates the control commands C1 to Cn for the control target elements 5_1 to 5_n. Then, the control unit 16_k generates a set group of the calculated control commands C1 to Cn as a control command group Gk. Note that the control command group is also referred to as “all control commands”.

In the example of FIG. 5, the control command determination unit 23 of the control unit 16_k receives the control command group Gj from the other control unit 16_j, and transmits the generated control command group Gk to the other control unit 16_j. That is, the control unit 16_k generates the control command Ck for the control target element 5_k while exchanging the control command group with the other control unit 16_j. Therefore, the control unit 16_k performs consensus control with the other control unit 16_j in the generation of the control command Ck and the input of the control command Ck to the control target facility 2. That is, a consensus control method for exchanging the control command groups G1 to Gn among the plurality of control units 16 is introduced in the generation of the control commands C1 to Cn. Note that the plurality of control units 16 generates the control command groups using different degradation indexes from one another. Therefore, the control commands C1 to Cn indicated by the control command group Gk may be different from the control commands C1 to Cn indicated by the ohter control command group Gj.

Further, in the example of FIG. 5, in the control unit 16_k, the evaluation value calculation unit 22 calculates the evaluation value indicating the appropriateness of the control command Ck calculated by the control command determination unit 23. The calculation of the evaluation value is performed similarly to the calculation of the evaluation value of the control command C by the evaluation value calculation unit 22 in the example of FIG. 4, for example. Then, in the control unit 16_k, the control command Ck is appropriately corrected, updated, and the like based on the evaluation value. As a result, the control command Ck to be input to the control target element 5_k is locally optimized by the control unit 16_k. That is, in each of the plurality of control units 16, the control command to be input to the corresponding one of the control target elements 5 is locally optimized based on a gradient. Note that, as in the example of FIG. 5, in each of the control units 16, the request (condition), the constraint, the objective function, and the like indicated by the operation command P are reflected in the calculation of the evaluation value in the evaluation value calculation unit 22.

In the example of FIG. 5, the plurality of control units 16 performs the consensus control of exchanging the control command groups G1 to Gn with one another in the generation of the control commands C1 to Cn, and each of the control units 16 locally optimizes the control command to be input to the corresponding one of the control target elements 5. In the control lineage in which the control commands C1 to Cn are generated as described above, the plurality of control units 16 generates the control command corresponding to the degradation index for each of the plurality of control target elements 5 based on the difference in the degradation index among the plurality of control target elements 5.

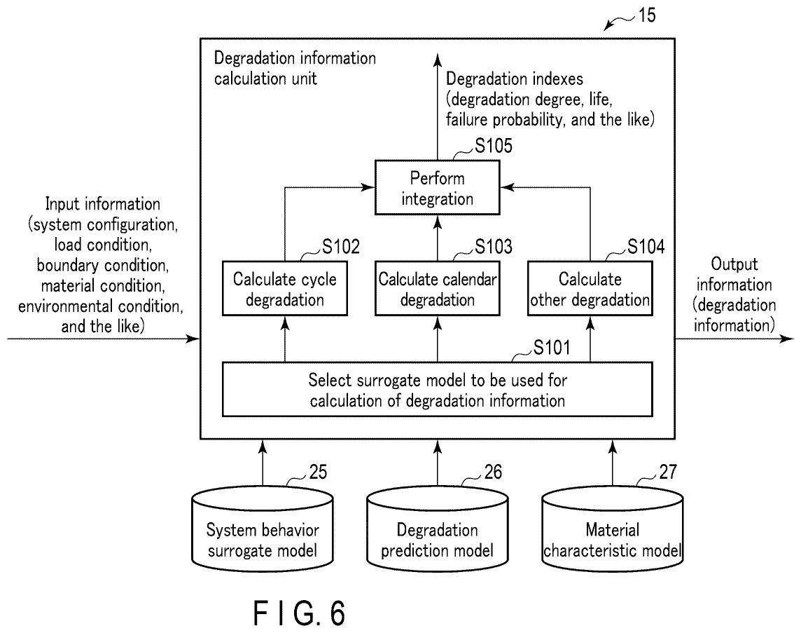

Next, calculation of the degradation information including calculation of the degradation index will be described. FIG. 6 is a schematic diagram for describing an example of processing of calculating the degradation information related to the degradation of the plurality of control target elements 5 in the embodiment. In the example of FIG. 6, the degradation information calculation unit 15 calculates the degradation information using a system behavior surrogate model 25, a degradation prediction model 26, and a material characteristic model 27. Each of the system behavior surrogate model 25, the degradation prediction model 26, and the material characteristic model 27 is stored in, for example, a storage medium serving as the storage unit 11. In the system behavior surrogate model 25, arithmetic expressions, functions, and the like related to a behavior of the control system 1 including the operation of the control target facility 2 are given.

A system configuration, a load condition, a boundary condition, a material condition, an environmental condition, and the like are input to the degradation information calculation unit 15 as input information. As the system configuration, the configuration of the control target facility 2 and information of components constituting each of the control target facility 2 and the control target element 5 and the like are indicated. Further, as the load condition, information regarding the load on the control target facility 2 is indicated, and is calculated using the above-described operation waveform. Further, as the boundary condition, information such as a method of installing the control target facility 2 and the control target element 5 in the control system 1 is indicated. Further, as the material condition, information such as material characteristics of the components of the control target facility 2 including the control target element 5 is indicated. Further, as the environmental condition, information regarding the environment in which the control target facility 2 is used is indicated, and for example, information such as an environmental temperature of the environment in which the control target facility 2 is used is indicated. Further, in a case where one or more of the control target elements 5 are cooled by the cooling fan or the like in the control target facility 2, information such as an operation state of the cooling fan is indicated as the environmental condition.

In the calculation of the degradation information, the degradation information calculation unit 15 selects a surrogate model to be used for the calculation from the system behavior surrogate model 25 based on the input information (S101). In the process of calculating the degradation information, a state variable related to the degradation of the control target element 5 is calculated. In S101, the surrogate model for estimating the state variable related to the degradation of the control target element 5 is selected. For example, in a case where the plurality of batteries (battery cells or battery modules) is provided as the plurality of control target elements 5, the surrogate model for estimating the temperature of the battery, the surrogate model for estimating electrical characteristics of the battery, and the like are selected.

Then, the degradation information calculation unit 15 performs calculation of cycle degradation (S102), calculation of calendar degradation (S103), and calculation of other degradation (S104) for one or more of the plurality of control target elements 5, using the selected surrogate models. The cycle degradation corresponds to degradation caused by an operation repeated over a plurality of cycles in the control target facility 2. The calendar degradation corresponds to degradation depending on a lapse of time. In the calculation of the degradation information, the degradation information calculation unit 15 integrates, for the one or more of the control target elements 5, a calculation result for the cycle degradation, a calculation result for the calendar degradation, and a calculation results for the other degradation (S105). In the integration in S105, after the calculation results for the degradation are normalized, similarly to a linear cumulative damage rule, the normalized calculation results may be linearly added, or weighting may be performed for each of a plurality of degradation factors and the calculation results for the degradation may be added. Further, similarly to a nonlinear cumulative damage rule, the calculation results of the degradation may be integrated using a nonlinear function.

The degradation information calculation unit 15 calculates, as the degradation indexes, the degradation degree (damage value), the life (the time or the number of cycles to reach the reference for failure), the failure probability (the time change in the failure probability), and the like, for one or more of the control target elements 5 by using the calculation result of S105 and the like. Then, the degradation information calculation unit 15 outputs the degradation information including the calculated degradation indexes as output information. For example, in the case where the plurality of batteries (battery cells or battery modules) is provided as the plurality of control target elements 5, the degradation indexes such as the degradation degree, the life, and the failure probability are calculated for one or more of the plurality of batteries, and the degradation information including the calculated degradation indexes is output as the output information.

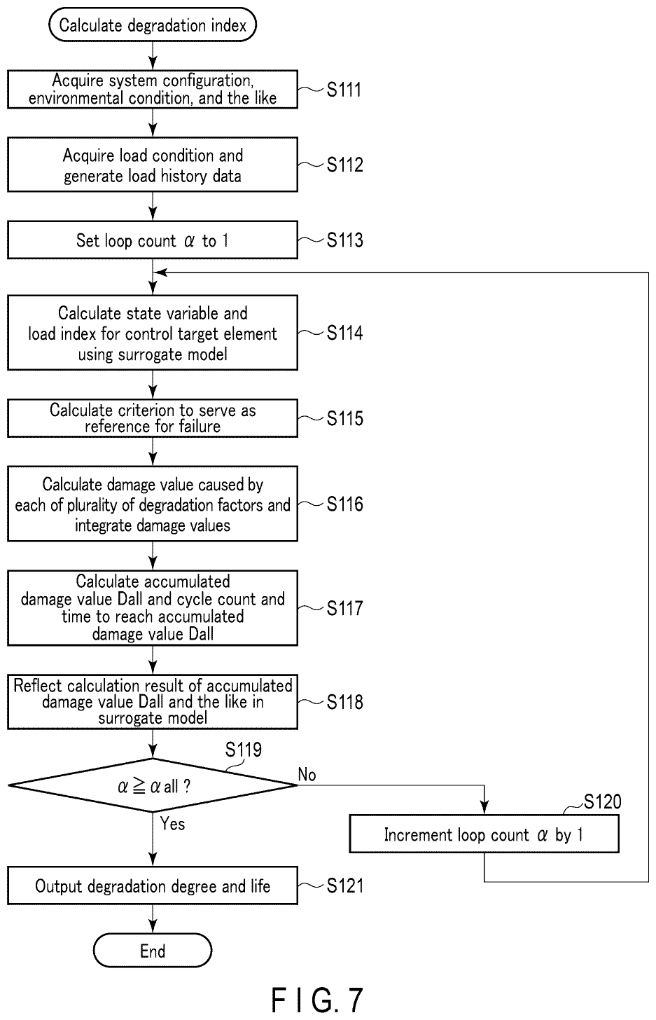

FIG. 7 is a flowchart schematically illustrating a first example of processing of calculating the degradation indexes for one or more of the plurality of control target elements 5 in the embodiment. In the example of FIG. 7, an example of calculating the degradation degree (damage value) and the life for one or more of the control target elements 5 as the degradation indexes will be described. When the processing of the example of FIG. 7 is started, the degradation information calculation unit 15 acquires the system configuration (the structure of the control target facility 2), the boundary condition, the material condition, the environmental condition, and the like from the input information (S111). As each of the system configuration, the boundary condition, the material condition, and the environmental condition, the above-described information is indicated.

Then, the degradation information calculation unit 15 acquires the load condition from the input information, and generates load history data indicating the time change in the load on the control target facility 2 based on the load condition (S112). The time change in the load indicated by the load history data is calculated using the operation waveform input from the control target facility 2. The load history data indicates the load history up to the present time point, that is, the load history in the past, for the control target facility 2. Further, in the example of FIG. 7, the load history data indicates the load history of the control target facility 2 after the present time point in a case where the control target facility 2 continues the operation similar to the load history up to the present time point. Further, in the generated load history data, the waveform of the time change in the load on the control target facility 2 indicates that the load repeatedly acts on the control target facility 2 over call cycles (call is a natural number of 2 or more). Therefore, in the load history data, the total number of cycles αall is defined. The total number of cycles αall is also referred to as “the number of cycle count data rows”.

Further, in the example of FIG. 7, a loop count α is defined as a parameter. When generating the load history data, the degradation information calculation unit 15 sets the loop count α to 1 (initial value) (S113). In the case of performing the processing of S113, the degradation information calculation unit 15 performs calculation processing of S114 to S118 one cycle at a time in time order, starting with the earliest, for the call cycles of the load history data. At this time, first, the degradation information calculation unit 15 calculates, for the one or more of the control target elements 5, the state variable and the time change in the state variable in one cycle to be calculated using the surrogate model based on the input information and the load history data (S114). Then, the degradation information calculation unit 15 calculates, for one or more of the control target elements 5, a load index and a time change in the load index in one cycle to be calculated based on the time change in the state variable (S114).

Here, in a case where the control target element 5 is a battery, the current, the voltage, the temperature, and the like of the battery are calculated as the state variables, and a current history, a voltage history, a temperature history, and the like are calculated as the time changes in the state variables. Further, the load index corresponds to a vector (load vector) obtained by combining the above-described state variables related to the degradation. For example, in the case where the control target element 5 is a battery, a combined vector of the current, the voltage, the temperature, and the like of the battery is calculated as the load index.

Then, the degradation information calculation unit 15 calculates, for one or more of the control target elements 5, the criterion that serves as the reference for a failure using the degradation prediction model or the like based on the time changes in the state variables and the load index up to the cycle to be calculated (S115). The criterion that serves as the reference for a failure is affected by the state variables and changes corresponding to the state variables such as the current and the temperature. Therefore, the criterion is updated based on the time change in the state variables and the load index for each cycle of the load history data.

Then, the degradation information calculation unit 15 calculates, for one or more of the control target elements 5, the damage value caused by each of a plurality of degradation factors in one cycle to be calculated based on the state variables and the load index (S116). Then, the degradation information calculation unit 15 integrates the damage values caused by the plurality of degradation factors (S116), whereby a total damage value in one cycle to be calculated is calculated as a degradation progress in one cycle, for one or more of the control target elements 5. At this time, for one cycle to be calculated, the damage value caused by cycle degradation, the damage value caused by calendar degradation, and the like are calculated. Then, by adding the calculated damage values, the total damage value in one cycle to be calculated is calculated. In the calculation of the total damage value, the damage values may be linearly added to each other, or weighting may be performed for each of the plurality of degradation factors and the damage values may be added to each other. Further, similarly to a nonlinear cumulative damage rule, the damage values may be integrated with each other using a nonlinear function.

Then, the degradation information calculation unit 15 calculates, for one or more of the control target elements 5, an accumulated damage value Dall up to an end of the cycle to be calculated (S117). At this time, the accumulated damage value Dall up to the end of the cycle to be calculated is calculated by accumulating (adding) all the damage values in the cycle to be calculated to the accumulated damage value Dall at the start of the cycle to be calculated. Further, the degradation information calculation unit 15 calculates the time to reach the calculated accumulated damage value Dall, and calculates a cycle count of the control target facility 2 to reach the calculated accumulated damage value Dall in a case where the control target facility 2 repeats the operation over a plurality of cycles (S117).

Then, the degradation information calculation unit 15 reflects the calculation result in S117 including the calculation result of the accumulated damage value Dall in the surrogate model (S118). In the surrogate model that estimates the state variables of the control target element 5 such as the temperature and the electrical characteristics of the control target element 5, if the degradation degree of the control target element 5 increases, it is necessary to change parameters used for the estimation of the state variables. For example, in the case where the control target element 5 is a battery, if the degradation degree of the battery increases, an electric resistance of the battery increases, and a heat generation amount by the battery increases. Therefore, in the surrogate model, it is necessary to change the parameters used for the estimation of the electrical characteristics and the temperature of the battery. In the example of FIG. 7, the parameters used for the estimation of the state variables in the surrogate model are updated every cycle of the load history data by the processing of S118.

Then, the degradation information calculation unit 15 determines whether or not the loop count α is equal to or larger than the total number of cycles αall of the load history data (S119). In a case where the loop counts α is smaller than the total number of cycles αall (S119—No), the degradation information calculation unit 15 increments the loop count α by 1 (S120). Then, the processing returns to S114, and the degradation information calculation unit 15 sequentially executes the processing of S114 and subsequent steps. Therefore, the calculation processing of S114 to S118 is performed for the next one cycle of the load history data.

On the other hand, in a case where the loop count α is equal to or larger than the total number of cycles call (S119—Yes), the degradation information calculation unit 15 calculates and outputs the degradation degree and the life in real time for one or more of the control target elements 5 (S121). The degradation degree in real time is calculated based on the accumulated damage value Dall up to a time point corresponding to the present time point in the load history data. Further, the life is indicated by the time, the cycle count of the control target facility 2, or the like when the load index, the degradation degree, or the like reaches the criterion serving as the reference of a failure.

By performing the processing of the example of FIG. 7, in a state where the operation is repeated over a plurality of cycles in the control target facility 2, the degradation progress is calculated for each cycle for one or more of the plurality of control target elements 5, and the degradation information including an integrated value of the degradation progress for each cycle for one or more of the control target elements 5 is calculated. As a result, for one or more of the control target elements 5, the integrated value of the degradation progress up to the present time point is calculated as the degradation degree. Further, for one or more of the control target elements 5, the time or the cycle count at which the integrated value of the degradation progression degree reaches the criterion is calculated as the life.

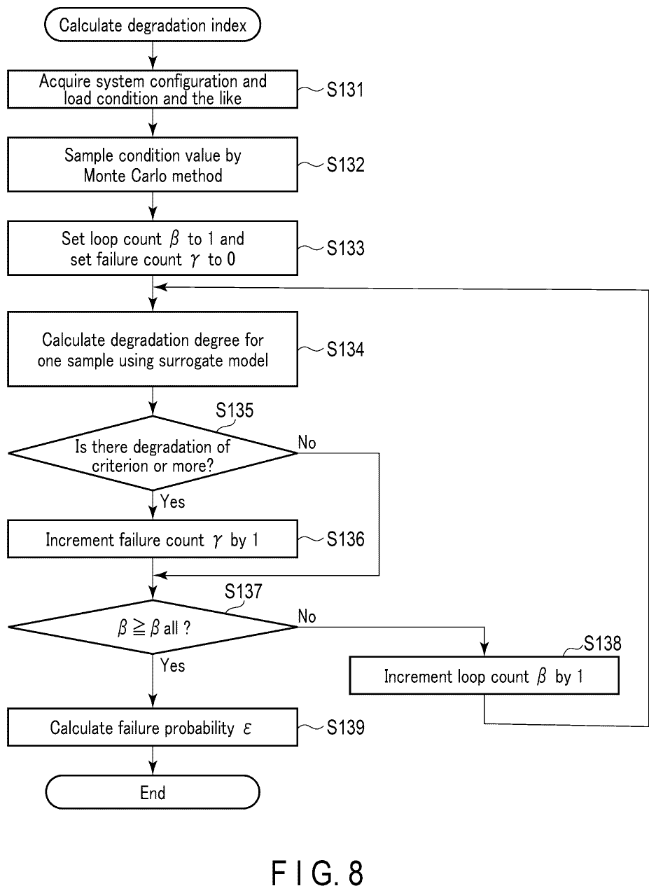

FIG. 8 is a flowchart schematically illustrating a second example of the processing of calculating the degradation index for one or more of the plurality of control target elements 5 in the embodiment. In the example of FIG. 8, an example of calculating the failure probability as the degradation index for any one of the control target elements 5 will be described. Note that the failure probability can be calculated for each of the plurality of control target elements 5 by performing processing similar to the example of FIG. 8. When the processing of the example of FIG. 8 is started, the degradation information calculation unit 15 acquires the system configuration (the structure of the control target facility 2), the load condition, the boundary condition, the material condition, the environmental condition, and the like from the input information (S131). As each of the system configuration, the load condition, the boundary condition, the material condition, and the environmental condition, the above-described information is indicated.

Then, the degradation information calculation unit 15 expresses uncertainty in the above-described condition indicated by the input information as a probability distribution, and samples a condition value indicated as the above-described condition by a Monte Carlo method (S132). Here, the total number of samples Ball in the sampling in S132 is defined. The total number of samples βall is also referred to as “maximum calculation count”.

Further, in the example of FIG. 8, a loop count β and a failure count γ are defined as parameters. In a case of performing sampling, the degradation information calculation unit 15 sets the loop count β to 1 (initial value) and sets the failure count γ to 0 (initial value) (S133). In a case of performing the processing of S133, the degradation information calculation unit 15 performs calculation processing of S134 and the subsequent steps for each one of the sampled samples. At this time, first, the degradation information calculation unit 15 calculates, for one sample, the degradation degree of the control target element 5 at a predetermined time point using the surrogate model (S134). At this time, for example, by performing processing similar to that in the example of FIG. 7, it is possible to calculate the degradation degree at the predetermined time point as the degradation index for the control target element 5.

Then, the degradation information calculation unit 15 determines whether or not the control target element 5 is degraded to the criterion or more, which serves as the reference for failure, at the predetermined time point based on the calculation result of the degradation degree (S135). In a case where the control target element 5 is degraded to the criterion or more (S135—Yes), the degradation information calculation unit 15 increments the failure count γ by 1 (S136). Then, the degradation information calculation unit 15 determines whether or not the loop count β is the total number of samples Ball or more in sampling (S137). On the other hand, in a case where the degradation degree of the control target element 5 is lower than the criterion (S135—No), the degradation information calculation unit 15 proceeds to the processing of S137 without performing the processing of S136, that is, without incrementing the failure count Y.

In the processing of S137, in a case where the loop count β is smaller than the total number of samples Ball (S137—No), the degradation information calculation unit 15 increments the loop count β by 1 (S138). Then, the processing returns to S134, and the degradation information calculation unit 15 sequentially executes the processing of S134 and subsequent steps. Therefore, the calculation processing in and after S134 is performed for the next sample.

On the other hand, in a case where the loop count β is the total number of samples Ball or more (S137—Yes), the degradation information calculation unit 15 calculates and outputs the failure probability ε at the predetermined time point for the control target element 5 (S139). The failure probability ε at the predetermined time point corresponds to a ratio (γ/βall) of a final calculation result of the failure count γ with respect to the total number of samples βall. Further, in the embodiment, by calculating the failure probability ε at each of the plurality of time points for the control target element 5 by the processing of the example of FIG. 8, it is possible to calculate the time change (time history) in the failure probability ε for the control target element 5.

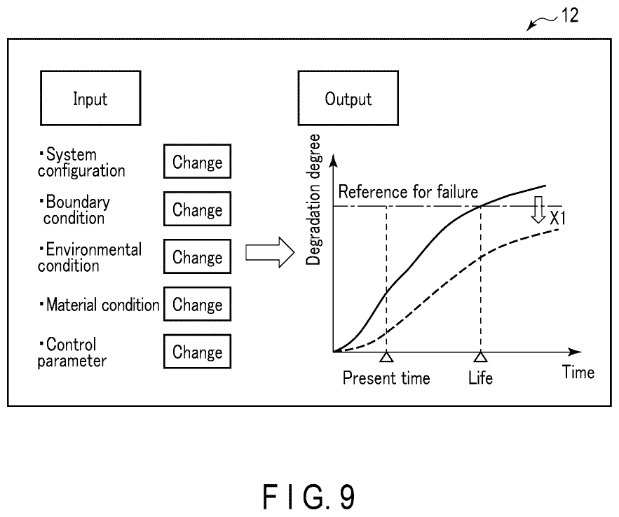

Further, in the embodiment and the like, it is possible to notify the calculation result of the degradation index for one or more of the plurality of control target elements 5 by display or the like on the user interface 12. FIG. 9 is a schematic diagram illustrating an example of a display screen that displays the calculation result of the degradation index for one of the plurality of control target elements 5 in the embodiment. The display screen of the example of FIG. 9 is displayed on, for example, a monitor or the like constituting the user interface 12. In the display screen of the example of FIG. 9, the system configuration, the boundary condition, the environmental condition, a material condition, and a control parameter are displayed as the input information. Then, as the output information, the time change in the degradation degree is indicated for one of the control target elements 5. In the graph of the output information, the abscissa axis represents time, and the ordinate axis represents the degradation degree. Note that, in the example of FIG. 9, the time change in the degradation degree is displayed as the output information, but the time change in the failure probability or the like may be displayed.

In the output information of the example of FIG. 9, the time when the degradation degree reaches the reference for failure is indicated as the life in addition to the degradation degree at the present time point (real time) for the control target element 5. In addition, in the display screen of the example of FIG. 9, the conditions indicated by the input information can be changed as appropriate. For example, the degradation degree of the control target element 5 in the output information is changed from the time change illustrated with the solid line in FIG. 9 to the time change illustrated with the broken line in FIG. 9 by the change of the condition (arrow X1). As a result, it is possible to compare the time change in the degradation degree before the condition is changed and after the condition is changed, and it is possible to compare which of the two conditions is appropriate.

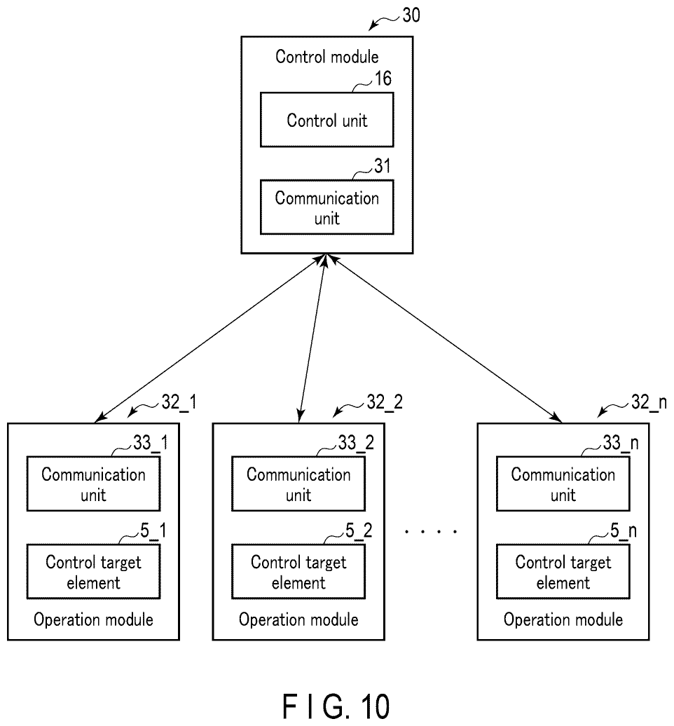

Next, a communication lineage that communicates the operation waveforms, control commands, and the like in the control system 1 will be described. FIG. 10 is a block diagram schematically illustrating a first example of a communication lineage in the control system 1 according to the embodiment. In the example of FIG. 10, the control system 1 includes a control module 30 and the same number of operation modules 32_1 to 32_n as the number of control target elements 5_1 to 5_n. The control module 30 includes the above-described control unit 16 and a communication unit 31. Further, each of the operation modules 32_1 to 32_n includes a corresponding one of the control target elements 5_1 to 5_n and a corresponding one of the communication units 33_1 to 33_n. Note that, in the following description, they are referred to as the control target element(s) 5, the operation module(s) 32, the communication unit(s) 33, and the like unless otherwise specified.

In the example of FIG. 10, the communication unit 31 of the control module 30 can communicate with the communication unit 33 of each of all the operation modules 32 in a wireless or wired manner. Therefore, the communication unit 31 receives the operation waveform and the like of the control target element 5 from each of the operation modules 32, and transmits the control command to the control target element 5 to each of the operation modules 32. Therefore, in the example of FIG. 10, the control unit 16 of the control module 30 performs centralized control for the operations of the plurality of control target elements 5.

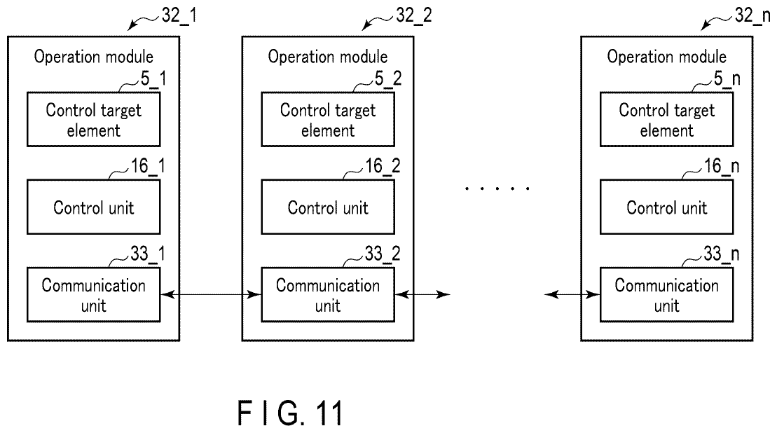

FIG. 11 is a block diagram schematically illustrating a second example of the communication lineage 1 in the control system according to the embodiment. In the example of FIG. 11, the control system 1 includes the same number of operation modules 32_1 to 32_n as the number of control target elements 5_1 to 5_n, and the control module 30 and the like are not provided. Each of the operation modules 32_1 to 32_n includes a corresponding one of the control target elements 5_1 to 5_n, a corresponding one of the control units 16_1 to 16_n, and a corresponding one of the communication units 33_1 to 33_n. Note that, in the following description, they are referred to as the control target element(s) 5, the control unit(s) 16, the operation module(s) 32, the communication unit(s) 33, and the like unless otherwise specified.

In the example of FIG. 11, each communication unit 33 of the operation module 32 can communicate with the communication units 33 of the other operation modules 32 in a wireless or wired manner. For this reason, each control unit 16 of the operation module 32 exchanges information regarding the control command to the control target element 5 with the other operation modules 32. For example, the control unit 16_k of the operation module 32_k receives the control command group Gj from the other operation module 32_j, and transmits the generated control command group Gk to the other operation module 32_j. In this case, the control unit 16_k of the operation module 32_k generates the control command Ck of the control target element 5_k while exchanging the control command group with the other control unit 16_j. Since such processing is performed, in the example of FIG. 11, distributed control by the control units 16 of the plurality of operation modules 32 is performed for the operations of the plurality of control target elements 5.

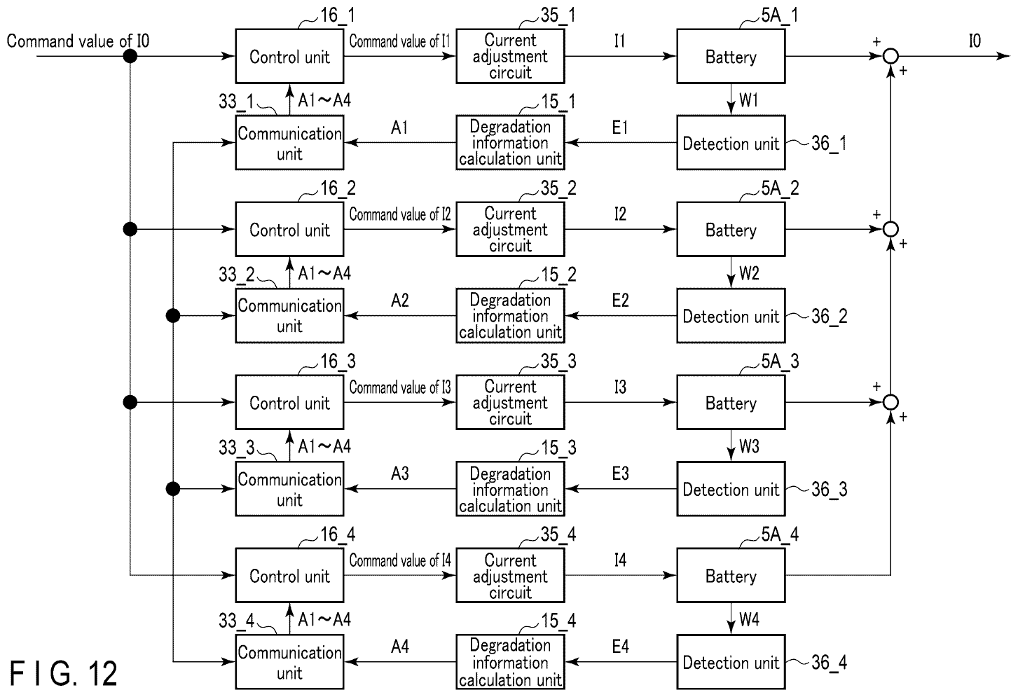

Next, as a specific example of the control system 1 in which the above-described control is performed, the control system 1 in which the storage battery facility (storage battery system) is the control target facility 2 will be described. FIG. 12 is a block diagram schematically illustrating a first example of a control lineage that controls a storage battery facility to serve as a control target facility 2 in the embodiment. In the example of FIG. 12, in the storage battery facility, four batteries (battery cells or battery modules) 5A_1 to 5A_4 are provided as the control target elements 5, and a power storage unit, in which the batteries 5A_1 to 5A_4 are electrically connected in parallel, is formed. Note that, in the following description, an example provided with four batteries 5A will be described. However, similar processing to that in the example of FIG. 12 is performed for any of two, three, or five or more batteries as long as there is a plurality of batteries 5A.

Here, similarly to the description of the above-described embodiment and the like, assuming that any one of the natural numbers of 1 or more and 4 or less is k and a value other than the natural number k of 1 or more and 4 or less is j, a current Ik is defined in a battery 5A_k. Further, in the storage battery facility, a total value of currents I1 to I4 of the batteries 5A_1 to 5A_4 is a current I0 of the entire power storage unit by the batteries 5A_1 to 5A_4. In addition, in the control system 1 of the example of FIG. 12, the degradation information calculation units 15_1 to 15_4, the control units 16_1 to 16_4, the communication units 33_1 to 33_4, current adjustment circuits 35_1 to 35_4, and detection units 36_1 to 36_4 are provided. Therefore, four degradation information calculation units 15, four control units 16, four communication units 33, four current adjustment circuits 35, and four detection units 36 are provided, that is, the same number as the number of batteries 5A are provided. Further, in the following description, they are simply referred to as the battery (batteries) 5A, the degradation information calculation unit(s) 15, the control unit(s) 16, the communication unit(s) 33, the current adjustment circuit(s) 35, and the detection unit(s) 36 unless otherwise specified.

Hereinafter, processing related to the battery 5A_k will be described. In the control system of the example of FIG. 12, the processing related to each of the batteries 5A_1 to 5A_4 is performed similarly to the processing to be described below. In the example of FIG. 12, the command value of the current I0 in the entire power storage unit is input to the control unit 16_k as the operation command P (request on the global side) from the outside. The control unit 16_k generates the control command to the battery 5A_k by, for example, performing consensus control with the other control units 16_j in a state where the current I0 corresponds to the command value.

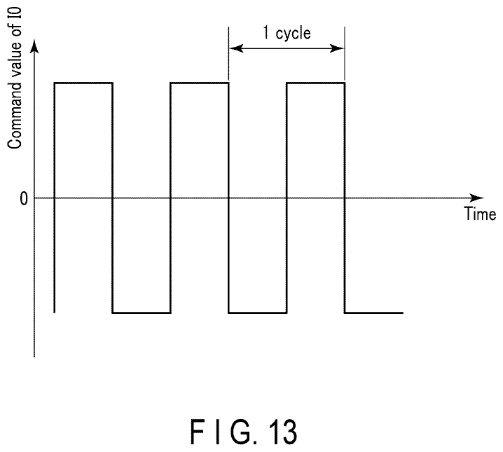

FIG. 13 is a schematic diagram illustrating an example of an operation command P input to each of four control units 16_1 to 16_4 in the example of FIG. 12. In the example of FIG. 13, the abscissa axis represents time, and the ordinate axis represents the command value of the current I0 in the entire power storage unit. In the example of FIG. 13, the waveform of the current I0 is input to each of the control units 16 as the operation command P, and a charge-discharge cycle of charging and discharging the power storage unit is repeated over a plurality of cycles with the waveform of the current I0 that is the operation command P. In FIG. 13, a time length corresponding to one cycle of the charge-discharge cycle of the power storage unit is illustrated in the waveform of the current I0 that is the operation command P.

In the example of FIG. 12, the detection unit 36_k detects the operation waveform Wk of the battery 5A_k. At this time, as the operation waveform Wk of the battery 5A_k, for example, waveforms indicating respective time changes in a state of charge (SOC), an open circuit voltage (OCV), a closed circuit voltage (CCV), the current Ik, and the temperature of the battery 5A_k are detected. Then, the detection unit 36_k transmits a detection signal Ek indicating a detection result of the operation waveform Wk to the degradation information calculation unit 15_k. Then, the degradation information calculation unit 15_k calculates the degradation index (degradation information) Ak of the battery 5A_k based on at least the operation waveform Wk indicated by the detection signal Ek.

In one example, in the calculation of the degradation index Ak, the degradation information calculation unit 15_k calculates, for the battery 5A_k, a difference value ΔSOC between the maximum value and the minimum value of the soc, an average value MOCV of the OCV, an average value MCrate of a C rate, and the temperature T for each cycle of the charge-discharge cycle of the power storage unit based on at least the operation waveform Wk. The average value MCrate of the Crate is calculated based on the time change in the current Ik of the battery 5A_k in one cycle. Then, the degradation information calculation unit 15_k calculates a degradation progression degree ΔDk of the battery 5A_k in one cycle of the charge-discharge cycle from Expression (1), using the difference value ΔSOC of the soc, the average value MOCV of the OCV, the average value MCrate of the C rate, and the temperature T.

Then, as given in Expression (2), the degradation information calculation unit 15_k calculates the integrated value of the degradation progression degree ΔDk for each cycle as the degradation degree (cumulative degradation amount) Dk for the battery 5A_k. As a result, the degradation degree Dk of the battery 5A_k is calculated as the degradation index Ak (degradation information) of the battery 5A_k. The degradation information calculation unit 15_k sets the value of the degradation degree Dk, which is the reference for failure, to 1 for the battery 5A_k. Then, the degradation information calculation unit 15_k calculates, as the life, the time or the cycle count of the charge-discharge cycle during which the degradation degree Dk that is the integrated value of the degradation progress ΔDk becomes 1 for the battery 5A_k. As a result, the life of the battery 5A_k is calculated as the degradation index Ak (degradation information) of the battery 5A_k.

$$Δ Dk = f ( Δ SOC , MOCV , MCrate , T ) \qquad ( 1 )$$

$$Dk = \sum Δ Dk \qquad ( 2 )$$

The communication unit 33_k acquires the degradation index Ak of the battery 5A_k calculated by the degradation information calculation unit 15_k. Furthermore, the communication unit 33_k transmits the information regarding the degradation index Ak of the battery 5A_k to the other communication units 33_j, and receives the information regarding the degradation indexes Aj of the batteries 5A_j from the other communication units 33_j. Therefore, the degradation indexes Aj of the batteries 5A_j are input from the communication unit 33_k to the control unit 16_k in addition to the degradation index Ak of the battery 5A_k. As a result, the control unit 16_k acquires the degradation indexes A1 to A4 of all the batteries 5A_1 to 5A_4.

In the example of FIG. 12, in the generation of the control command Ck for the battery 5A_k, the control unit 16_k performs consensus control with the other control units 16_j by communicating with the other control units 16_j via the communication unit 33_k, or the like. Then, the control unit 16_k performs the consensus control with the other control units 16_j to generate the control command Ck indicating the command value of the current Ik of the battery 5A_k. At this time, the control unit 16_k generates the control command Ck indicating the command value of the current Ik in the state of suppressing the variation in degradation among the batteries 5A_1 to 5A_4 based on the degradation indexes A1 to A4 of the batteries 5A_1 to 5A_4. Further, the control unit 16_k generates the control command Ck indicating the command value of the current Ik in a state where the total value of the currents I1 to I4 corresponds to the command value of the current I0 in the operation command P in cooperation with the other control units 16_j.

In the example of FIG. 12, the control unit 16_k calculates the command value of the current Ik of the battery 5A_k by substituting n=4 into Expression (3), using the degradation indexes A1 to A4 of the batteries 5A_1 to 5A_4. In Expression (3), the first term on the right side contributes to satisfying the command value of the current I0 of the power storage unit, which is the condition in the operation command P. In addition, in Expression (3), the second term on the right side contributes to performing consensus control for suppressing the variation in degradation of the batteries 5A_1 to 5A_4 corresponding to the degradation indexes A1 to A4. Since the power storage unit is repeatedly charged and discharged, the current I0 in the entire power storage unit can take a positive value and a negative value. Furthermore, & in Expression (3) is a control gain, and in the present embodiment, & is a value other than zero (ξ≠0). Further, since the total value of the currents I1 to I4 is the current I0, the command value of the current Ik calculated by Expression (3) satisfies the relationship of Expression (4) with respect to the command value of the current I0.

$$\begin{matrix}Ik = \frac{I 0}{n} - \frac{I 0}{\vert I 0 \vert} ξ & {\sum }_{j} ( Dk - Dj )\end{matrix} \qquad ( 3 )$$

$$I 0 = {\sum }_{k} Ik \qquad ( 4 )$$

In the example of FIG. 12, the control unit 16_k inputs the control command Ck indicating the command value of the current Ik to the current adjustment circuit 35_k, so that the current adjustment circuit 35_k operates in a state where the current Ik corresponding to the command value indicated by the control command Ck flows to the battery 5A_k. As a result, the variation in degradation among the batteries 5A_1 to 5A_4 is suppressed, and the current flows through the battery 5A_k in a state where the current I0 corresponds to the command value in the operation command P.

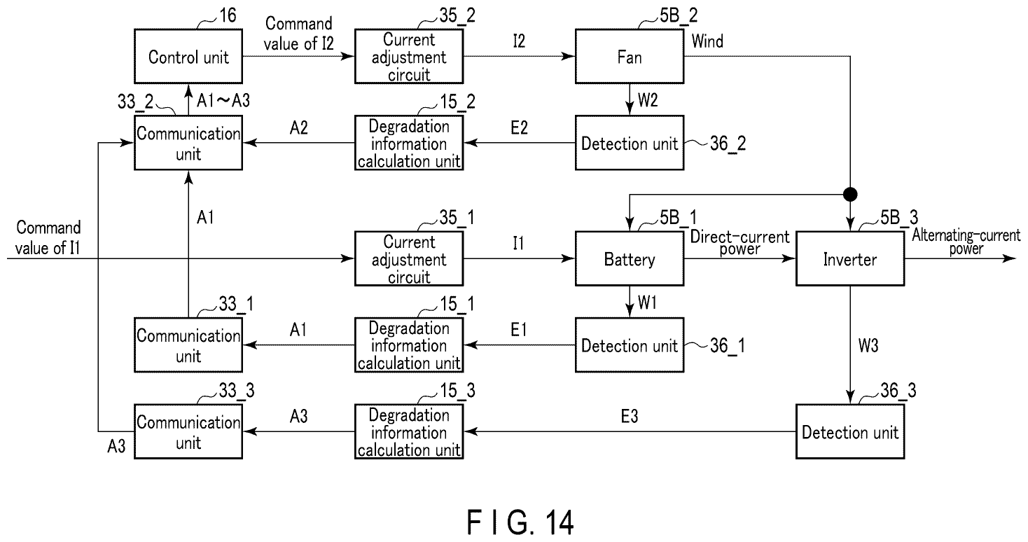

FIG. 14 is a block diagram schematically illustrating a second example of the control lineage that controls the storage battery facility to serve as the control target facility 2 in the embodiment. In the example of FIG. 14, in the storage battery facility, a battery (battery cell or battery module) 5B_1, a fan (cooling fan) 5B_2, and an inverter 5B_3 are provided as the control target element 5. In addition, in the control system 1 of the example of FIG. 14, the degradation information calculation units 15_1 to 15_3, the communication units 33_1 to 33_3, and the detection units 36_1 to 36_3 are provided. Therefore, three degradation information calculation units 15, three communication units 33, and three detection units 36, that is, the same number as the control target elements 5 (battery, fan, and inverter), are provided.

In addition, the control system 1 is provided with the control unit 16, and is provided with a current adjustment circuit 35_1 that adjusts the current I1 of the battery 5B_1 and a current adjustment circuit 35_2 that adjusts the current of the fan 5B_2. Note that, in the following description, they are simply referred to as the degradation information calculation unit(s) 15, the communication unit(s) 33, the current adjustment circuit(s) 35, and the detection unit(s) 36 unless otherwise specified.

In the control lineage of the example of FIG. 14, the command value of the current I1 of the battery 5B_1 is input as the operation command P for the control target facility 2 including the battery 5B_1, the fan 5B_2, and the inverter 5B_3. The current adjustment circuit 35_1 operates in a state where the current I1 corresponding to the command value indicated by the operation command P flows through the battery 5B_1. As a result, the current I1 corresponding to the command value in the operation command P flows through the battery 5B_1. Further, in the example of FIG. 14, the inverter 5B_3 converts direct-current power output from the battery 5B_1 into alternating-current power, and outputs the alternating-current power from the storage battery facility to serve as the control target facility 2. Further, the inverter 5B_3 converts the alternating-current power to the storage battery facility into the direct-current power, and inputs the direct-current power to the battery 5B_1.

Further, in the example of FIG. 14, a flow of wind (air) is generated from the fan 5B_2 toward each of the battery 5B_1 and the inverter 5B_3 as the fan 5B_2 operates. Therefore, the air amount from the fan 5B_2 to each of the battery 5B_1 and the inverter 5B_3 changes as the rotation amount of the fan 5B_2 changes. Therefore, the operation state of the fan 5B_2 affects the operation of each of the battery 5B_1 and the inverter 5B_3.

In the example of FIG. 14, the detection unit 36_1 detects the operation waveform W1 of the battery 5B_1. At this time, as the operation waveform W1 of the battery 5B_1, for example, a waveform indicating the time change in any of the current, voltage, or temperature of the battery 5B_1 is detected. Then, the detection unit 36_1 transmits a detection signal E1 indicating a detection result of the operation waveform W1 to the degradation information calculation unit 15_1, and the degradation information calculation unit 15_1 calculates the degradation index (degradation information) A1 of the battery 5B_1 based at least on the operation waveform W1 indicated by the detection signal E1. Then, the communication unit 33_1 acquires the degradation index A1 of the battery 5B_1 calculated by the degradation information calculation unit 15_1.

Further, in the example of FIG. 14, the detection unit 36_2 detects the operation waveform W2 of the fan 5B_2. At this time, as the operation waveform W2 of the fan 5B_2, for example, a waveform indicating the time change in either the current or the rotation amount of the fan 5B_2 is detected. Then, the detection unit 36_2 transmits a detection signal E2 indicating a detection result of the operation waveform W2 to the degradation information calculation unit 15_2, and the degradation information calculation unit 15_2 calculates the degradation index (degradation information) A2 of the fan 5B_2 based at least on the operation waveform W2 indicated by the detection signal E2. Then, the communication unit 33_2 acquires the degradation index A2 of the fan 5B_2 calculated by the degradation information calculation unit 15_2.

Further, in the example of FIG. 14, the detection unit 36_3 detects the operation waveform W3 of the inverter 5B_3. At this time, as the operation waveform W3 of the inverter 5B_3, for example, a waveform indicating the time change in either the current or the temperature of the inverter 5B_3 is detected. Then, the detection unit 36_3 transmits a detection signal E3 indicating a detection result of the operation waveform W3 to the degradation information calculation unit 15_3, and the degradation information calculation unit 15_3 calculates the degradation index (degradation information) A3 of the inverter 5B_3 based at least on the operation waveform W3 indicated by the detection signal E3. Then, the communication unit 33_3 acquires the degradation index A3 of the inverter 5B_3 calculated by the degradation information calculation unit 15_3.

In the example of FIG. 14, the communication unit 33_2 can communicate with the communication units 33_1 and 33_3. Then, the communication unit 33_2 receives the degradation index A1 of the battery 5B_1 from the communication unit 33_1, and receives the degradation index A3 of the inverter 5B_3 from the communication unit 33_3. In addition, the communication unit 33_2 inputs the degradation information including the degradation index A1 of the battery 5B_1, the degradation index A2 of the fan 5B_2, and the degradation index A3 of the inverter 5B_3 to the control unit 16.

In the example of FIG. 14, the control unit 16 generates the control command indicating the command value of the current I2 of the fan 5B_2 based on the degradation indexes A1 to A3 indicated by the degradation information. In the example of FIG. 14, the control unit 16 generates the control command for the fan 5B_2, but does not generate the control command for each of the battery 5B_1 and the inverter 5B_3. The control unit 16 inputs the control command indicating the command value of the current I2 to the current adjustment circuit 35_2, so that the current adjustment circuit 35_2 operates in a state where the current I2 corresponding to the command value indicated by the control command flows through the fan 5B_2.

Even in the example of FIG. 14, the control command to the fan 5B_2 is generated in a state in which the variation in degradation among the battery 5B_1, the fan 5B_2, and the inverter 5B_3, which are the control target elements 5, is suppressed. For example, in a case where the degradation degree of the fan 5B_2 is higher than the degradation degree of each of the battery 5B_1 and the inverter 5B_3, the command value of the current I2 of the fan 5B_2 is decreased in the control command. As a result, the load on the fan 5B_2 is reduced. On the other hand, in a case where the degradation degree of the fan 5B_2 is lower than the degradation degree of each of the battery 5B_1 and the inverter 5B_3, the command value of the current I2 of the fan 5B_2 is increased in the control command. As a result, since the air amount from the fan 5B_2 increases in each of the battery 5B_1 and the inverter 5B_3, the temperature of each of the battery 5B_1 and the inverter 5B_3 decreases, and the load of each of the battery 5B_1 and the inverter 5B_3 is reduced.

In the embodiment or the like, as described above, the control command C related to the operation of the plurality of control target elements 5 is generated in the state of suppressing the variation in degradation among the plurality of control target elements 5 based on the degradation information A related to the degradation of the plurality of control target elements 5. Then, by inputting the generated control command C to the control target facility 2 including the plurality of control target elements 5, the operation corresponding to the control command C is executed in the control target facility 2. As a result, in the control target facility 2 including the plurality of control target elements 5, it is possible to appropriately operate the control target facility 2 while suppressing the variation in degradation among the plurality of control target elements 5. Further, in the embodiment or the like, the operation of the control target facility 2 is controlled to the state in which the variation in degradation among the plurality of control target elements 5 is suppressed while the operation of the control target facility 2 including the control target elements 5 is continued.

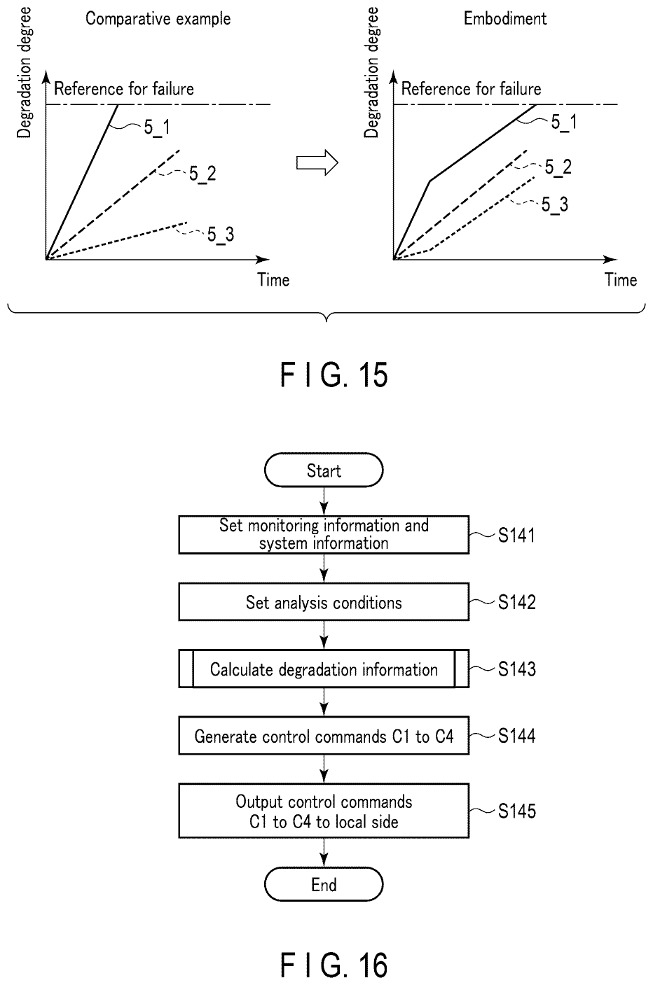

FIG. 15 is a schematic diagram for describing an effect in a case where the control by the control unit 16 is performed in the embodiment. FIG. 15 illustrates, in comparison, in the operation control of the control target facility 2 including the three control target elements 5_1 to 5_3, a case where control of a comparative example is performed and a case where the control of the embodiment is performed, such as the case where the above-described consensus control is performed. In the comparative example, the control command is generated in a state where the request indicated by the operation command P is satisfied, but the control command is generated without considering the variation in degradation among the control target elements 5_1 to 5_3. On the other hand, in the embodiment, as described above, the control command is generated in the state where the request indicated by the operation command P is satisfied and the variation in degradation among the control target elements 5_1 to 5_3 is suppressed.

In FIG. 15, for each of the comparative example and the embodiment, the time change in the degradation degree of each of the control target elements 5_1 to 5_3 is illustrated by a graph. In the graphs of the comparative example and the embodiment, the abscissa axis represents time, and the ordinate axis represents the degradation degree. As illustrated in FIG. 15, in the comparative example, when a certain amount of time has elapsed from the start of use, the variation in degradation among the control target elements 5_1 to 5_3 increases. Even if the degradation degree of each of the control target elements 5_2 and 5_3 is small, the degradation degree of the control target element 5_1 having the fastest progress of degradation reaches the reference for failure at a relatively early stage after the start of use. Therefore, even if the degradation degree of each of the control target elements 5_2 and 5_3 is small, it is necessary to stop the operation of the entire control target facility 2 at a stage when the degradation degree of the control target element 5_1 reaches the reference for failure, that is, at a relatively early stage after the start of use, and the life of the control target facility 2 comes to an end.

Meanwhile, in the embodiment, the operation control of suppressing the variation in degradation among the control target elements 5_1 to 5_3 is performed. Therefore, in the control target element 5_3 having the slowest progress of degradation, the progress of degradation is faster than that in the comparative example. However, in the embodiment, in the control target element 5_1 having the fastest progress of degradation, the progress of degradation is slower than that in the comparative example. Then, the time until the degradation degree of the control target element 5_1 reaches the reference for failure is longer than that in the comparative example, and the life of the control target element 5_1 is longer than that in the comparative example. Therefore, in the embodiment, the life of the control target facility 2 is longer than that of the comparative example.

In addition, in the embodiment, by performing the consensus control in the generation of the control command C in a similar manner to the example of FIG. 5 and the like, both the request on the global side corresponding to the request in the operation command P and the request on the local side regarding each of the control target elements 5 are adjustable. In the embodiment, suppressing the variation in degradation among the plurality of control target elements 5 corresponds to the request on the local side. In addition, the consensus control in the generation of the control command C can be applied to the centralized control such as the example of FIG. 10, can also be applied to the distributed control such as the example of FIG. 11, and can also be applied to hybrid control in which the centralized control and the distributed control are combined. Therefore, in the control target facility 2 and the control system 1, robustness and scalability against a configuration change are appropriately ensured. For example, in the control target facility 2, it is possible to appropriately cope with a change of one or more types of the control target elements 5, addition of the control target element 5, and the like.

In the embodiment, the degradation information related to the degradation of the plurality of control target elements 5 is calculated using the surrogate model. For example, for one or more of the control target elements 5, the state variable is calculated using the surrogate model, and the degradation index is calculated based on the state variable. As a result, one or more state variables of the control target element 5 can be calculated at high speed by the surrogate model even in a complicated system configuration in which a plurality of constituent elements and the like has nonlinear interaction. Therefore, even in a complicated system configuration, one or more degradation indexes of the control target element 5 can be calculated at high speed.

In addition, as verification related to the embodiment, verification by simulation given below was performed. In the verification, simulation was performed for a control lineage that controls a storage battery facility similar to the example of FIG. 12. That is, simulation was performed using a storage battery facility in which the four batteries (battery cells) 5A_1 to 5A_4 serving as the control target elements 5 were electrically connected in parallel. Further, in the verification, the simulation was performed assuming that the waveform of the command value of the current I0 in the example of FIG. 13 is input to the storage battery facility as the operation command P (request on the global side). The simulation was performed assuming that the charge-discharge cycle indicated by the waveform of the command value of the current I0 in the example of FIG. 13 is repeated over a plurality of cycles.

FIG. 16 is a flowchart schematically illustrating processing performed in verification related to the embodiment. As illustrated in FIG. 16, in the verification by simulation, monitoring information and system information were set (S141), and analysis conditions were set (S142). As the analysis conditions, the system configuration, the load condition, the boundary condition, the material condition, the environmental condition, and the like described above were set. Then, processing of calculating degradation information was performed using a model including the surrogate model (S143).

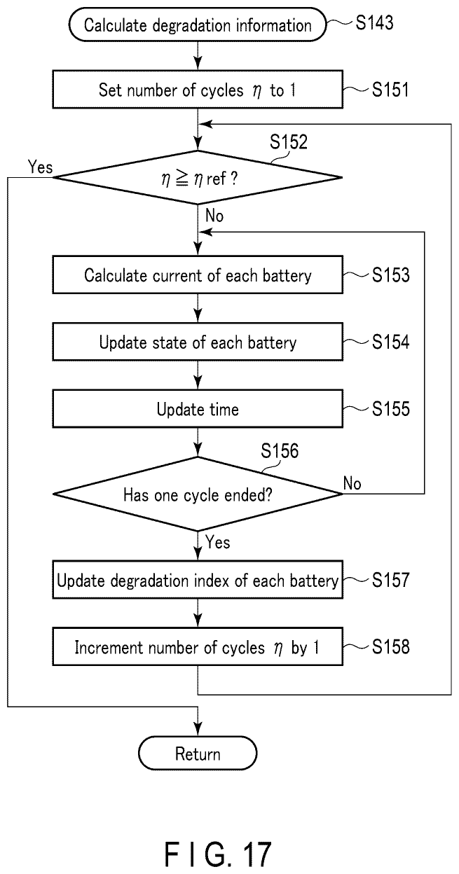

FIG. 17 is a flowchart schematically illustrating processing performed in processing of calculating degradation information of FIG. 16. In the processing of calculating degradation information in FIG. 17, the number of cycles η was defined as a parameter, and one of natural numbers of 2 or more was set as the reference number of cycles ηref. In the calculation processing of FIG. 17, first, the number of cycles η was set to 1 (S151), and it was determined whether the number of cycles η is the reference number of cycles ηref or more (S152). Then, in a case where the number of cycles η is smaller than the reference number of cycles ηref (S152—No), the current was calculated for each of the batteries 5A_1 to 5A_4 (S153), and the state was updated (S154). In the update of the state of each of the batteries, the SOC, the OCV, the CCV, and the temperature were updated for each of the batteries 5A. Then, the time was updated (S155), and it was determined whether one cycle of the charge-discharge cycle had ended (S156).

In a case where one cycle had not ended in step S156 (S156—No), the processing returned to S153, and the processing of S153 and subsequent steps was sequentially performed. Therefore, the processing of S153 to S155 was repeated in one cycle of the charge-discharge cycle. As a result, for each of the batteries 5A, the operation waveforms indicating the time change in the current and the time change in the states (SOC, OCV, CCV and temperature) were calculated. Further, in a case where one cycle had ended in S156 (S156—Yes), the degradation indexes were updated based on the operation waveform in one cycle for each of the batteries 5A (S157).

In the processing of S157, the difference value ΔSOC of the Soc, the average value MOCV of the OCV, the average value MCrate of the C rate, and the like in one cycle were calculated based on the operation waveform in one cycle for each of the batteries 5A. Then, the degradation progress in one cycle was calculated and the degradation progresses AD1 to AD4 were calculated using Expression (1) described above, for each of the batteries 5A. Then, the degradation degree was calculated as the degradation index and the degradation degrees D1 to D4 were calculated using Expression (2), for each of the batteries 5A. Further, in the processing of S157, for each of the batteries 5A, the time or the cycle count of the charge-discharge cycle in which the degradation degree that is the integrated value of the degradation progress during one cycle becomes 1 was calculated as the life.

When each degradation index of the battery 5A was updated, the number of cycles η was incremented by 1 (S158), and the processing returned to S152. Then, in a case where the number of cycles η was smaller than the reference number of cycles ηref (S152—No), the processing of S153 and subsequent steps was sequentially performed. On the other hand, in a case where the number of cycles η was the reference number of cycles ηref or more (S152—Yes), the processing of calculating the degradation information had ended. Then, for each of the batteries 5A, the latest update value in S157 was calculated as the degradation index at the time when the charge-discharge cycle was performed by the reference number of cycles ηref.

As illustrated in FIG. 16, in the verification, when the processing of calculating the degradation information (S143) had ended, the control command for each of the batteries 5A, that is, the control commands C1 to C4 were generated (S144). Then, the generated control commands C1 to C4 were output to the local side, and each of the control commands C1 to C4 was output to the corresponding one of the batteries 5A_1 to 5A_4 (S145). At this time, the control command C1 was generated as a command indicating the command value of the current I1, the control command C2 was generated as a command indicating the command value of the current I2, the control command C3 was generated as a command indicating the command value of the current I3, and the control command C4 was generated as a command indicating the command value of the current I4. Further, in the verification, the control commands C1 to C4 to be generated were simulated for each of the case where the control of the comparative example is performed and the case where the control of the example is performed.

Here, in the comparative example, the control commands C1 to C4 were generated in a state where the current I0 in the entire power storage unit satisfies the command value required in the operation command P but the variation in degradation among the batteries 5A_1 to 5A_4 was not considered. Actually, in the comparative example, the command values of the currents I1 to I4 in the control command were calculated and the control commands C1 to C4 were generated, assuming that ξ=0 and the second term on the right side becomes 0 in Expression (3) described above. Therefore, in the comparative example, the simulation was performed for the case where control for suppressing the variation in degradation among the batteries 5A_1 to 5A_4, such as consensus control, was not performed.

Meanwhile, in the example, the control commands C1 to C4 were generated in the state where the current I0 in the entire power storage unit satisfies the command value required in the operation command P and the variation in degradation among the batteries 5A_1 to 5A_4 is suppressed. Actually, in the example, the command values of the currents I1 to I4 in the control command were calculated and the control commands C1 to C4 were generated, assuming that ξ≠0 in Expression (3) and Expression (4) described above was satisfied. Therefore, in the example, similarly to the above-described embodiment and the like, the case where the control for suppressing the variation in degradation among the batteries 5A_1 to 5A_4 is performed by consensus control was simulated.

In the verification related to the embodiment, the operation waveform of each of the plurality of batteries 5A and the degradation indexes of each of the plurality of batteries 5A were calculated by simulation for each of the comparative example and the example. In the verification, the time changes in the current, the SOC, the OCV, and the CCV were calculated as the operation waveforms for each of the plurality of batteries 5A. Further, in the verification, the time changes in the degradation degree, the life, and the like were calculated as the degradation indexes, for each of the plurality of batteries 5A. FIGS. 18 to 21 illustrate a part of the calculation results by the simulation in the verification.

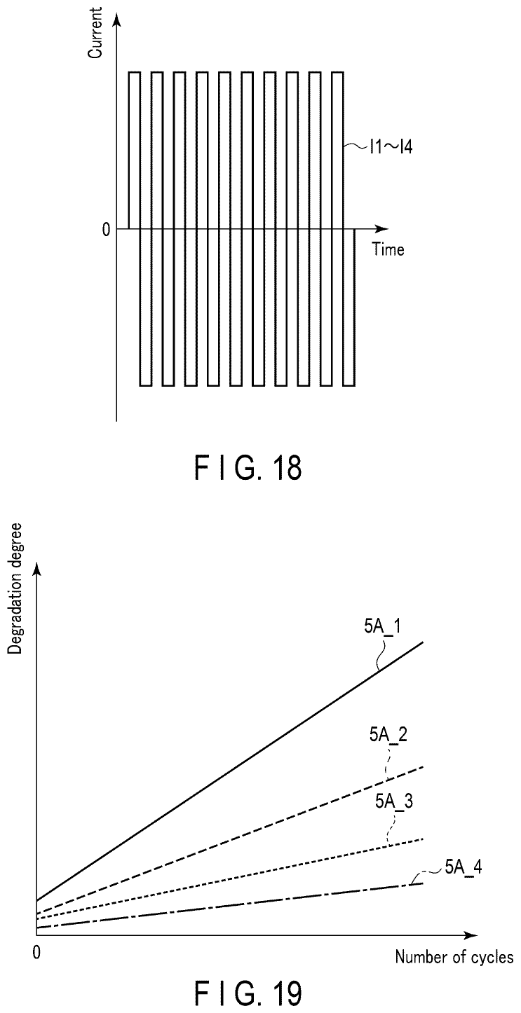

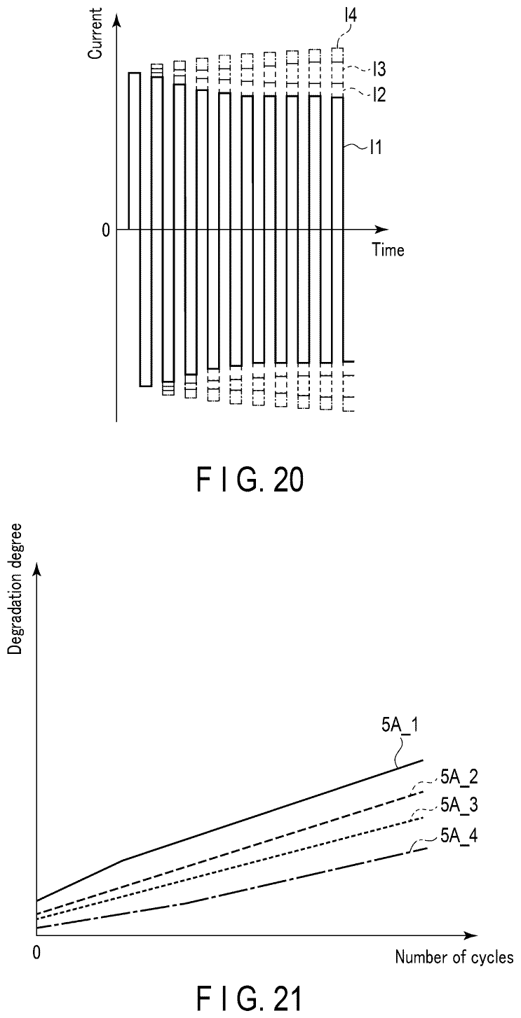

Here, FIG. 18 is a schematic diagram illustrating the time change in the current of each of the plurality of batteries 5A in the case of the comparative example calculated in the verification related to the embodiment, and FIG. 19 is a schematic diagram illustrating the time change in the degradation degree of each of the plurality of batteries 5A in the case of the comparative example calculated in the verification related to the embodiment. Further, FIG. 20 is a schematic diagram illustrating the time change in the current of each of the plurality of batteries 5A in the case of the example calculated in the verification related to the embodiment, and FIG. 21 is a schematic diagram illustrating the time change in the degradation degree of each of the plurality of batteries 5A in the case of the example calculated in the verification related to the embodiment. In each of FIGS. 18 and 20, the abscissa axis represents the time, and the ordinate axis represents the current. Further, in each of FIGS. 19 and 21, the abscissa axis represents the number of cycles of the charge-discharge cycle, and the ordinate axis represents the degradation degree.

In the comparative example, since the control for suppressing the variation in degradation among the batteries 5A_1 to 5A_4 is not performed as described above, the operation waveforms indicating the time change in the current were the same or substantially the same as each other, and the time change in the currents I1 to I4 were the same or substantially the same as each other, in the batteries 5A_1 to 5A_4, as illustrated in FIG. 18. Further, the time change in the SOC, the time change in the OCV, and the time change in the CCV were the same or substantially the same as each other in the batteries 5A_1 to 5A_4. Further, in the comparative example, in a case where the batteries 5A_1 to 5A_4 was continuously operated in the state where the current was the same or substantially the same, the variation in the degradation degree among the batteries 5A_1 to 5A_4 increased due to the difference in temperature among the batteries 5A_1 to 5A_4, as illustrated in FIG. 19.

Meanwhile, in the example, since the control for suppressing the variation in degradation among the batteries 5A_1 to 5A_4 is performed as described above, the operation waveforms indicating the time change in the current were different from each other in the batteries 5A_1 to 5A_4 due to the second term on the right side of Expression (3), as illustrated in FIG. 20. That is, the time changes in the currents I1 to I4 were different from each other. Further, the time change in the SOC, the time change in the OCV, and the time change in the CCV were different from each other in the batteries 5A_1 to 5A_4.

Further, as illustrated in FIG. 21, in the example, the batteries 5A_1 to 5A_4 were operated in different current states, so that the variation in the degradation degree among the batteries 5A_1 to 5A_4 was suppressed as compared with the comparative example. In particular, in the example, in the battery 5A_1 having the fastest progress of degradation, the progress of degradation was slower than that in the comparative example. Therefore, the time until the degradation degree of the battery 5A_1 reaches the reference for failure is longer than that in the comparative example, and the life of the battery 5A_1 is longer than that in the comparative example. Therefore, in the example, the life of the storage battery facility including the batteries 5A_1 to 5A_4 was longer than that in the comparative example.

In at least one of the above-described embodiments and examples, the control command related to the operation of the plurality of control target elements is generated in the state of suppressing the variation in degradation among the plurality of control target elements based on the degradation information related to the degradation of the plurality of control target elements. Then, the generated control command is input to the control target facility including the plurality of control target elements to cause the control target facility to execute the operation corresponding to the control command. It is possible to provide the control apparatus, the control system, the control method, and the control program that enable appropriate operation of the control target facility including the plurality of control target elements while suppressing the variation in degradation among the plurality of control target elements.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control apparatus comprising a control unit configured to generate a control command related to an operation of a plurality of control target elements in a state of suppressing a variation in degradation among the plurality of control target elements based on degradation information related to degradation of the plurality of control target elements, and input the generated control command to a control target facility including the plurality of control target elements to cause the control target facility to execute an operation corresponding to the control command.

2. The control apparatus according to claim 1, wherein the control unit generates a control command for one or more of the plurality of control target elements as the control command related to the operation of the plurality of control target elements based on a degradation index of each of the plurality of control target elements indicated by the degradation information, and causes the one or more of the plurality of control target elements to operate corresponding to the generated control command.

3. The control apparatus according to claim 1, wherein the control unit generates, for each of the plurality of control target elements, a control command corresponding to the degradation index as the control command related to the operation of the plurality of control target elements based on a difference in the degradation indexes between the plurality of control target elements indicated by the degradation information, and causes each of the plurality of control target elements to operate corresponding to the generated control command.

4. The control apparatus according to claim 1, wherein, in a case where a degradation degree of each of a first control target element and a second control target element among the plurality of control target elements is indicated by the degradation information, the control unit generates the control command related to the operation of the plurality of control target elements in a state in which a load that acts due to the control command is smaller in the second control target element than in the first control target element, based on a fact that the degradation degree of the second control target element is higher than the degradation degree of the first control target element.

5. The control apparatus according to claim 1, wherein
a plurality of control units each provided for each of the plurality of control target elements is provided as the control unit, and
each of the plurality of control units generates a control command for the operation of corresponding one of the plurality of control target elements as the control command related to the operation of the plurality of control target elements based on the degradation information, and causes the corresponding one of the plurality of control target elements to operate corresponding to the generated control command.

6. The control apparatus according to claim 1, wherein the control unit generates the control command related to the operation of the plurality of control target elements in a state of satisfying a request indicated by an operation command for the control target facility input from an outside in addition to suppressing the variation in degradation among the plurality of control target elements.

7. The control apparatus according to claim 1, further comprising a degradation information calculation unit configured to calculate the degradation information related to the degradation of the plurality of control target elements based on an operation waveform detected in the control target facility.

8. The control apparatus according to claim 7, wherein the degradation information calculation unit calculates the degradation information including a degradation index of each of the plurality of control target elements by using an operation waveform of each of the plurality of control target elements as the operation waveform.

9. The control apparatus according to claim 7, wherein the degradation information calculation unit calculates the degradation information related to the degradation of the plurality of control target elements by using a surrogate model.

10. The control apparatus according to claim 7, wherein the degradation information calculation unit calculates degradation progress for each one cycle for one or more of the plurality of control target elements and calculates the degradation information including an integrated value of the degradation progress of each one cycle for the one or more of the plurality of control target elements in a state where the operation is repeated over a plurality of cycles in the control target facility.

11. A control system comprising:
the control apparatus according to claim 1; and
the control target facility including the plurality of control target elements.

12. A control method comprising:
generating a control command related to an operation of a plurality of control target elements in a state of suppressing a variation in degradation among the plurality of control target elements based on degradation information related to degradation of the plurality of control target elements; and
inputting the generated control command to a control target facility including the plurality of control target elements to cause the control target facility to execute an operation corresponding to the control command.

13. A non-transitory storage medium storing a control program, the control program causing a computer to implement:
generating a control command related to an operation of a plurality of control target elements in a state of suppressing a variation in degradation among the plurality of control target elements based on degradation information related to degradation of the plurality of control target elements; and
inputting the generated control command to a control target facility including the plurality of control target elements to cause the control target facility to execute an operation corresponding to the control command.
